(19) United States
(12) Patent Application Publication
(10) Pub. No.: US 2026/0213965 A1
(43) Pub. Date: Jul. 23, 2026

(54) COMMUNICATION SYSTEM, SERVICE INVOCATION METHOD, AND APPARATUS

(71) Applicant: HUAWEI TECHNOLOGIES CO., LTD., Shenzhen (CN)

(72) Inventors: Donghui WANG, Beijing (CN); Xun XIAO, Munich (DE); Fei LIU, Singapore (SG)

(73) Assignee: HUAWEI TECHNOLOGIES CO., LTD., Shenzhen (CN)

(21) Appl. No.: 19/462,484

(22) Filed: Jan. 28, 2026

Related U.S. Application Data
(63) Continuation of application No. PCT/CN2023/112762, filed on Aug. 11, 2023.

(51) Int. Cl. H04L 9/00; H04W 12/00

(52) U.S. Cl. CPC H04L 9/50; H04W 12/009

(57) ABSTRACT

A communication system, a service invocation method, and an apparatus, relating to the field of wireless communication. In the communication system, a network function of a core network is deployed on a blockchain in a form of smart contract for invocation by a terminal, a radio access network node, an application function network element, a network function network element, or an operation, administration and maintenance network element. In this way, convergence of a blockchain network and the core network can be implemented, allowing communication behavior and various types of data in the communication system to be traceable and queryable, and enhancing communication security. In addition, a node in the communication system may obtain an invocation request, and invoke a smart contract on a blockchain based on the invocation request, to implement a corresponding network function.

### CROSS-REFERENCE TO RELATED APPLICATIONS

This application is a continuation of International Application No. PCT/CN2023/112762, filed on Aug. 11, 2023, the disclosure of which is hereby incorporated by reference in its entirety.

### TECHNICAL FIELD

The embodiments relate to the field of wireless communication, a communication system, a service invocation method, and an apparatus.

### BACKGROUND

Blockchain is a distributed ledger that integrates a plurality of technologies including cryptography, peer-to-peer (P2P) networking, and distributed-database technologies. As an open and transparent decentralization technology, blockchain transforms conventional authoritative centralization and centralized trust into collective consensus and decentralized trust respectively, and constructs a tamper-proof distributed ledger using the cryptography technology. In blockchain, data is generated and stored in blocks, and is connected into a chain data structure in chronological order.

Based on immutability of blockchain, the industry proposes the idea of introducing the blockchain technology into communication systems, to improve communication security between communication apparatuses in the communication systems. However, how to combine the blockchain technology with the communication systems is still an urgent problem to be resolved.

### SUMMARY

The embodiments provide a communication system, a service invocation method, and an apparatus, to implement convergence of a blockchain network and a core network, allowing communication behavior and various types of data in a communication system to be traceable and queryable, and enhancing communication security.

According to a first aspect, a communication system is provided. The communication system includes at least two nodes that are communicatively connected, the at least two nodes maintain at least one blockchain, at least one smart contract is deployed on the blockchain, and any one of the at least one smart contract has a network function of a core network.

Based on the communication system provided in the first aspect, the network function of the core network may be deployed on the blockchain in a form of smart contract, to implement convergence of a blockchain network and the core network. Data on the blockchain cannot be tampered with. Therefore, deploying the network function of the core network on the blockchain can prevent the network function from being tampered with, and improve communication security. In addition, the blockchain has a distributed architecture, so that the network function can be flexibly deployed on the blockchain. For example, the network function may be deployed on a plurality of blockchain nodes, for example, the foregoing at least two nodes. When a blockchain node fails, a service may be provided by using the network function on another blockchain node. Therefore, robustness of the communication system can be improved. In addition, the network function is deployed on the blockchain, so that an execution result of the network function can be recorded on the blockchain in a form of transaction, thereby facilitating tracing.

In a possible embodiment, the network function of the core network is configured to provide at least one of the following services: a subscription service, an authentication service, a registration service, a mobility management service, a policy management service, a data processing service, a charging service, a session management service, a computing service, a sensing service, or an artificial intelligence (artificial intelligence, AI) service.

Based on the foregoing possible embodiment, one or more of a plurality of services that can be provided by the network function of the core network may be deployed on the blockchain in a form of smart contract, to implement convergence of a blockchain network and the core network, and improve communication security.

In a possible embodiment, the at least two nodes include a first node and a second node, the at least one blockchain includes a first blockchain, the first node and the second node jointly maintain the first blockchain, a first smart contract and a second smart contract are deployed on the first blockchain, the first smart contract has a first network function of the core network, and the second smart contract has a second network function of the core network.

Based on the foregoing possible embodiment, a plurality of network functions of the core network may be deployed on one blockchain, to facilitate blockchain maintenance.

In a possible embodiment, the at least two nodes include a first node and a second node, the at least one blockchain includes a first blockchain and a second blockchain, the first node maintains the first blockchain, the second node maintains the second blockchain, a first smart contract is deployed on the first blockchain, a second smart contract is deployed on the second blockchain, the first smart contract has a first network function of the core network, and the second smart contract has a second network function of the core network.

Based on the foregoing possible embodiment, network functions of the core network may be deployed on a plurality of blockchains, so that an amount of data on each blockchain is relatively small, thereby facilitating maintenance and management.

In a possible embodiment, information about the first smart contract is stored in the first blockchain or the first node, and the information about the first smart contract includes an identifier of the first smart contract.

Based on the foregoing possible embodiment, the identifier of the first smart contract may be stored in the first blockchain or the first node, to distinguish between different smart contracts.

In a possible embodiment, the information about the first smart contract further includes at least one of the following: an identifier of the first blockchain, information about an execution node of the first smart contract, information about a node on which the first smart contract is deployed, key information of the first smart contract, token access manner information of the first smart contract, version information of the first smart contract, an input parameter of the first network function, or information about the first network function.

Based on the foregoing possible embodiment, at least one of the foregoing information may be stored in the first blockchain or the first node for the first smart contract. The identifier of the first blockchain may be used to determine a blockchain on which the first smart contract is located. For example, if a plurality of blockchains are deployed on the first node, the first node may determine, based on the identifier of the first blockchain, that the first smart contract is deployed on the first blockchain. For another example, if another node reads the identifier of the first blockchain from the information about the first smart contract, the another node may determine that the first smart contract is deployed on the first blockchain, and may subsequently invoke the first smart contract on the first blockchain. The information about the execution node of the first smart contract may be used to determine the execution node for executing the first smart contract. For example, the first node may determine, based on the information, whether the first node is an execution node of the first smart contract and specific execution nodes of the first smart contract. For another example, if another node reads the information about the execution node from the information about the first smart contract, the another node may determine specific execution nodes on which the first smart contract is deployed, and may subsequently invoke the first smart contract on these execution nodes. The information about the node on which the first smart contract is deployed may be used to determine the node on which the first smart contract is deployed. For example, the first node may determine, based on the information, specific nodes on which the first smart contract is deployed. For another example, if another node reads the information from the information about the first smart contract, the another node may determine specific execution nodes on which the first smart contract is deployed, and may subsequently query these execution nodes for related information about the first smart contract.

The key information of the first smart contract may include a public key, a public key certificate, a private key, and the like of the first smart contract, and be used by the first node to verify whether a node that is to invoke the first smart contract is valid, to improve communication security. The token access manner information of the first smart contract may be used to determine a token access manner of the first smart contract, for example, identifiers of smart contracts that can be accessed by the first smart contract, and/or validity periods of smart contracts that can be accessed by the first smart contract, to subsequently invoke these smart contracts. The version information of the first smart contract may be used to determine a version of the first smart contract, so that the first node determines whether to upgrade the first smart contract, or when another node invokes the first smart contract, the another node determines whether an invoked version is correct. The input parameter of the first network function may be used to determine an input parameter of a network function corresponding to the first smart contract, to provide a corresponding parameter when another node invokes the first network function. The information about the first network function may be used to determine a network function corresponding to the first smart contract, so that the first node or another node determines the network function provided by the first smart contract.

In a possible embodiment, the communication system further includes a third node, and the third node is configured to parse an invocation request for a service, to obtain invocation information of at least one smart contract corresponding to the invocation request for the service.

Based on the foregoing possible embodiment, the third node may parse/translate the invocation request for the service into the invocation information corresponding to the smart contract, to invoke the smart contract based on the invocation information, and implement a corresponding network function by using the smart contract. In the foregoing process, a node that initiates the invocation request for the service, for example, a terminal, a radio access network node, an application function network element, a network function network element, or an operation, administration and maintenance network element, may not have a capability of invoking a smart contract. After the node sends the invocation request for the service, the third node determines the smart contract that needs to be invoked to invoke the service. Therefore, this embodiment is applicable to both a node that has a capability of invoking a smart contract and a node that does not have a capability of invoking a smart contract, so that compatibility of this embodiment can be improved. In addition, because the node that initiates the invocation request for the service may not have a capability of invoking a smart contract, complexity of the node can be reduced, and a requirement on performance of the node is relatively low.

In a possible embodiment, the invocation request for the service is from one or more of a terminal, a radio access network node, an application function network element, a network function network element, or an operation, administration and maintenance network element.

Based on the foregoing possible embodiment, different types of requesters may be supported in initiating service invocation requests.

In a possible embodiment, any one of the at least two nodes is configured to receive an invocation request for a smart contract.

Based on the foregoing possible embodiment, any one of the at least two nodes can invoke a smart contract.

In a possible embodiment, the invocation request for the smart contract is from one or more of a terminal, a radio access network node, an application function network element, a network function network element, or an operation, administration and maintenance network element.

Based on the foregoing possible embodiment, different types of requesters may be supported in initiating smart contract invocation.

In a possible embodiment, the network function of the core network includes at least one of the following: an access function, a mobility management function, a network repository function, unified data management, an authentication server function, a session management function, a user plane function, a policy control function, a network exposure function, a computing plane function, a data plane function, or a smart plane function.

Based on the foregoing possible embodiment, one or more of the foregoing network functions may be deployed on a blockchain in a form of smart contract, to implement convergence of a blockchain network and the core network, and improve communication security.

In a possible embodiment, the communication system further includes a radio access network node communicatively connected to the at least two nodes, and the radio access network node is configured to invoke the smart contract deployed on the at least one blockchain.

Based on the foregoing possible embodiment, the radio access network node in the communication system may invoke a smart contract that has a network function of the core network.

In a possible embodiment, the communication system further includes a network element of the core network that is communicatively connected to the at least two nodes, and the network element of the core network is configured to invoke the smart contract deployed on the at least one blockchain, or the network element of the core network is configured to provide a service for the smart contract deployed on the at least one blockchain.

Based on the foregoing possible embodiment, in the communication system, some network functions are deployed on the blockchain in a form of smart contract, and some network functions are deployed in the communication system in a form of service-based architecture, to reduce network deployment costs, and gradually converge the core network and a blockchain network.

According to a second aspect, a service invocation method is provided. The method may be performed by a third node; or may be performed by a module, for example, a chip, a chip system, or a circuit, used in the third node; or may be implemented by a logical node, a logical module, or software that can implement all or some functions of the third node. This is not limited. For ease of description, the following uses an example in which the third node performs the method for description. Optionally, the third node is an apparatus that has a communication capability and a computing capability, or the third node is a blockchain node. The method includes: obtaining an invocation request for a first service; and determining invocation information of at least one smart contract corresponding to the invocation request for the first service. Any one of the at least one smart contract is deployed on a blockchain and has a network function of a core network.

Based on the method provided in the second aspect, the third node may obtain the invocation request for the first service, and determine the invocation information of the at least one smart contract corresponding to the invocation request for the first service, to subsequently invoke the smart contract based on the invocation information, thereby invoking the first service. In the foregoing method, the third node has a capability of parsing the invocation request for the first service. Therefore, a node (for example, a terminal, a radio access network node, an application function network element, a network function network element, or an operation, administration and maintenance network element) that initiates service invocation may not have a capability of invoking a smart contract.

This can simplify an operation of the node that initiates service invocation, improve compatibility of the method provided in the second aspect, and reduce complexity of the node that initiates service invocation, and a requirement on performance of the node that initiates service invocation is relatively low. In addition, because the smart contract is deployed on the blockchain and has the network function of the core network, the network function can be prevented from being tampered with, thereby improving communication security. In addition, the blockchain has a distributed architecture, so that the smart contract can be flexibly deployed on the blockchain. For example, the smart contract is deployed on a plurality of blockchain nodes corresponding to the blockchain. When a blockchain node fails, execution of the smart contract is not affected, so that robustness of a communication system can be improved.

In a possible embodiment, the network function of the core network is configured to provide at least one of the following services: a subscription service, an authentication service, a registration service, a mobility management service, a policy management service, a data processing service, a charging service, a session management service, a computing service, a sensing service, or an AI service.

Based on the foregoing possible embodiment, one or more of the foregoing services may be deployed on a blockchain in a form of smart contract, to implement convergence of a blockchain network and the core network, and improve communication security.

In a possible embodiment, the at least one smart contract includes a first smart contract, and the method further includes: sending a first invocation request, where the first invocation request is used to invoke the first smart contract.

Based on the foregoing possible embodiment, when determining that the smart contract corresponding to the invocation request for the first service includes the first smart contract, the third node may invoke the first smart contract by using the first invocation request.

In a possible embodiment, the sending the first invocation request includes: sending the first invocation request to a scheduling node of the first smart contract; or sending the first invocation request to an execution node of the first smart contract.

Based on the foregoing possible embodiment, the third node may directly send the first invocation request to the execution node of the first smart contract, or send the first invocation request to the execution node of the first smart contract through the scheduling node of the first smart contract, to adapt to different network architectures.

In a possible embodiment, the method further includes: receiving an execution result of the first smart contract.

Based on the foregoing possible embodiment, the execution result of the first smart contract may be obtained, to determine whether the first smart contract is successfully executed.

In a possible embodiment, the method further includes: sending the invocation information of the at least one smart contract.

Based on the foregoing possible embodiment, a node that receives the invocation information, for example, an execution node of the at least one smart contract, may invoke the smart contract based on the invocation information.

In a possible embodiment, the at least one smart contract further includes a second smart contract, the first smart contract is used to invoke the second smart contract, and the method further includes: sending a second invocation request, where the second invocation request is used to invoke the second smart contract.

Based on the foregoing possible embodiment, when determining that the smart contract corresponding to the invocation request for the first service includes the second smart contract, the third node may invoke the second smart contract by using the second invocation request.

In a possible embodiment, the sending the second invocation request includes: sending the second invocation request to a scheduling node of the second smart contract; or sending the second invocation request to an execution node of the second smart contract.

Based on the foregoing possible embodiment, the third node may directly send the second invocation request to the execution node of the second smart contract, or send the second invocation request to the execution node of the second smart contract through the scheduling node of the second smart contract, to adapt to different network architectures.

In a possible embodiment, the method further includes: receiving an execution result of the second smart contract.

Based on the foregoing possible embodiment, the execution result of the second smart contract may be obtained, to determine whether the second smart contract is successfully executed.

In a possible embodiment, the first smart contract has a first network function of the core network, and the second smart contract has a second network function of the core network.

Based on the foregoing possible embodiment, the third node may invoke the first smart contract to provide the first network function for a node that initiates the invocation request for the first service, for example, a terminal, a radio access network node, an application function network element, a network function network element, or an operation, administration and maintenance network element, and invoke the second smart contract to provide the second network function for the node that initiates the invocation request for the first service.

In a possible embodiment, the first invocation request includes an identifier of the first smart contract and an input parameter of the first network function.

Based on the foregoing possible embodiment, a node that receives the first invocation request, for example, the execution node of the first smart contract, may determine to execute the first smart contract, and when executing the first smart contract, input the input parameter of the first network function into the first smart contract.

In a possible embodiment, the first invocation request further includes at least one of the following: an identifier of a blockchain on which the first smart contract is located, information about the execution node of the first smart contract, information about a node on which the first smart contract is deployed, key information of the first smart contract, token access manner information of the first smart contract, version information of the first smart contract, or information about the first network function.

Based on the foregoing possible embodiment, the first invocation request may include at least one of the foregoing information. The identifier of the blockchain on which the first smart contract is located may enable a node that receives the first invocation request to determine the blockchain on which the first smart contract is located, so as to determine a smart contract to be invoked by using the first invocation request. The information about the execution node of the first smart contract may enable a node that receives the first invocation request to determine specific execution nodes of the first smart contract, or determine whether the node is an execution node of the first smart contract. The information about the node on which the first smart contract is deployed may enable a node that receives the first invocation request to determine specific nodes on which the first smart contract is deployed, or determine whether the first smart contract is deployed on the node.

The key information of the first smart contract may include a public key or a public key certificate of the first smart contract, and be used by a node that receives the first invocation request to verify whether the third node is valid, to improve communication security. The token access manner information of the first smart contract may enable a node that receives the first invocation request to determine a token access manner of the first smart contract, for example, identifiers of smart contracts that can be accessed by the first smart contract, and/or validity periods of smart contracts that can be accessed by the first smart contract, to subsequently invoke these smart contracts. The version information of the first smart contract may enable a node that receives the first invocation request to determine a version of the first smart contract invoked by using the first invocation request, to perform comparison with a version of the first smart contract deployed on the execution node of the first smart contract, and determine whether the first invocation request can invoke the first smart contract deployed on the execution node of the first smart contract. The information about the first network function may enable a node that receives the first invocation request to determine a network function corresponding to the first smart contract.

In a possible embodiment, the first network function is an access function, a mobility management function, a network repository function, unified data management, an authentication server function, a session management function, a user plane function, a policy control function, a network exposure function, a computing plane function, a data plane function, or a smart plane function.

Based on the foregoing possible embodiment, the network function may be deployed on a blockchain in a form of smart contract, to implement convergence of a blockchain network and the core network, and improve communication security.

In a possible embodiment, the obtaining the invocation request for the first service includes: receiving the invocation request for the first service from a terminal, a radio access network node, an application function network element, a network function network element, or an operation, administration and maintenance network element.

Based on the foregoing possible embodiment, the invocation request for the first service may be obtained from the terminal, the radio access network node, the application function network element, the network function network element, or the operation, administration and maintenance network element. For example, the terminal, the radio access network node, the application function network element, the network function network element, or the operation, administration and maintenance network element may initiate the invocation request for the first service to the third node.

In a possible embodiment, the invocation information of the at least one smart contract indicates the at least one smart contract and an invocation sequence of the at least one smart contract.

Based on the foregoing possible embodiment, the third node may determine the at least one smart contract and the invocation sequence of the at least one smart contract, to invoke the at least one smart contract in the determined invocation sequence. When a plurality of smart contracts may implement one service, the plurality of smart contracts may be invoked in an invocation sequence indicated by invocation information, to invoke the service.

In a possible embodiment, the method further includes: sending an invocation result for the first service.

Based on the foregoing possible embodiment, a node that receives the invocation result for the first service, for example, a node that initiates the invocation request for the first service, may determine whether the first service is successfully invoked.

According to a third aspect, a service invocation method is provided. The method may be performed by a first node; or may be performed by a module, for example, a chip, a chip system, or a circuit, used in the first node; or may be implemented by a logical node, a logical module, or software that can implement all or some functions of the first node. This is not limited. For ease of description, the following uses an example in which the first node performs the method for description. Optionally, the first node is a blockchain node. The method includes: obtaining a first invocation request used to invoke a first smart contract, and executing the first smart contract to obtain an execution result of the first smart contract. The first smart contract is deployed on a first blockchain, and the first smart contract has a first network function of a core network.

Based on the method provided in the third aspect, the first node may obtain the first invocation request, and execute the first smart contract based on the first invocation request, to invoke the first smart contract. Because the first smart contract has the first network function, executing the first smart contract by the first node is equivalent to invoking the first network function, so that the first network function is invoked. In addition, because the first smart contract is deployed on the first blockchain, the first smart contract can be prevented from being tampered with, thereby improving communication security. In addition, the blockchain has a distributed architecture, so that the first smart contract can be flexibly deployed on the first blockchain. For example, the first smart contract is deployed on a plurality of blockchain nodes corresponding to the first blockchain. When a blockchain node fails, execution of the first smart contract is not affected, so that robustness of a communication system can be improved. In addition, the execution result of the first smart contract may be recorded on the first blockchain in a form of transaction, to facilitate tracing.

In a possible embodiment, the first network function is configured to provide a subscription service, an authentication service, a registration service, a mobility management service, a policy management service, a data processing service, a charging service, a session management service, a computing service, a sensing service, or an AI service.

Based on the foregoing possible embodiment, at least one of the foregoing services may be deployed on a blockchain in a form of smart contract, to implement convergence of a blockchain network and the core network, and improve communication security.

In a possible embodiment, the first smart contract is used to invoke a second smart contract, and the method further includes: sending a second invocation request, where the second invocation request is used to invoke the second smart contract.

Based on the foregoing possible embodiment, when the first smart contract is used to invoke the second smart contract, the second smart contract may be invoked by using the second invocation request.

In a possible embodiment, the sending the second invocation request includes: sending the second invocation request to a scheduling node of the second smart contract; or sending the second invocation request to an execution node of the second smart contract.

Based on the foregoing possible embodiment, the first node may directly send the second invocation request to the execution node of the second smart contract, or send the second invocation request to the execution node of the second smart contract through the scheduling node of the second smart contract, to adapt to different network architectures.

In a possible embodiment, the method further includes: receiving an execution result of the second smart contract.

Based on the foregoing possible embodiment, the execution result of the second smart contract may be obtained, to determine whether the second smart contract is successfully executed.

In a possible embodiment, the second smart contract has a second network function of the core network.

Based on the foregoing possible embodiment, the second smart contract may have a network function different from that of the first smart contract.

In a possible embodiment, the first invocation request includes an identifier of the first smart contract and an input parameter of the first network function.

Based on the foregoing possible embodiment, the first node may determine to execute the first smart contract, and when executing the first smart contract, input the input parameter of the first network function into the first smart contract.

In a possible embodiment, the first invocation request further includes at least one of the following: an identifier of the first blockchain, information about an execution node of the first smart contract, information about a node on which the first smart contract is deployed, key information of the first smart contract, token access manner information of the first smart contract, version information of the first smart contract, or information about the first network function.

Based on the foregoing possible embodiment, the first invocation request may include at least one of the foregoing information. The identifier of the first blockchain may enable the first node to determine a blockchain on which the first smart contract is located, so as to determine, in the blockchain, a smart contract to be invoked by using the first invocation request. The information about the execution node of the first smart contract may enable the first node to determine specific execution nodes of the first smart contract, or determine whether the first node is an execution node of the first smart contract. The information about the node on which the first smart contract is deployed may enable the first node to determine specific nodes on which the first smart contract is deployed, or determine whether the first smart contract is deployed on the first node.

The key information of the first smart contract may include a public key or a public key certificate of the first smart contract, and may enable the first node to verify whether a third node is valid, to improve communication security. The token access manner information of the first smart contract may enable the first node to determine a token access manner of the first smart contract, for example, identifiers of smart contracts that can be accessed by the first smart contract, and/or validity periods of smart contracts that can be accessed by the first smart contract, to subsequently invoke these smart contracts. The version information of the first smart contract may enable the first node to determine a version of the first smart contract invoked by using the first invocation request, to perform comparison with a version of the first smart contract deployed on the first node, and determine whether the first invocation request can invoke the first smart contract deployed on the first node. The information about the first network function may enable the first node to determine a network function corresponding to the first smart contract.

In a possible embodiment, obtaining the first invocation request includes: receiving the first invocation request from a scheduling node of the first smart contract, a terminal, a radio access network node, an application function network element, a network function network element, an operation, administration and maintenance network element, or an execution node of a third smart contract, where the third smart contract is used to invoke the first smart contract.

Based on the foregoing possible embodiment, the first invocation request may be obtained from the scheduling node of the first smart contract, the terminal, the radio access network node, the application function network element, the network function network element, the operation, administration and maintenance network element, or the execution node of the third smart contract used to invoke the first smart contract.

In a possible embodiment, the first network function is an access function, a mobility management function, a network repository function, unified data management, an authentication server function, a session management function, a user plane function, a policy control function, a network exposure function, a computing plane function, a data plane function, or a smart plane function.

Based on the foregoing possible embodiment, the network function may be deployed on a blockchain in a form of smart contract, to implement convergence of a blockchain network and the core network, and improve communication security.

According to a fourth aspect, a service invocation method is provided. The method may be performed by a node (for example, a terminal, a radio access network node, an application function network element, a network function network element, or an operation, administration and maintenance network element) that initiates service invocation; or may be performed by a module, for example, a chip, a chip system, or a circuit, used in the node that initiates service invocation; or may be implemented by a logical node, a logical module, or software that can implement all or some functions of the node that initiates service invocation. This is not limited. For ease of description, the following uses an example in which the node that initiates service invocation performs the method for description. The method includes: determining a first invocation request used to invoke a first smart contract, and sending the first invocation request. The first smart contract is deployed on a first blockchain, and the first smart contract has a first network function of a core network.

Based on the method provided in the fourth aspect, the node that initiates service invocation may initiate invocation of the first smart contract, so that an execution node of the first smart contract executes the first smart contract based on the first invocation request, to implement the first network function. Because the first smart contract is deployed on the first blockchain, the first smart contract can be prevented from being tampered with, thereby improving communication security. In addition, the blockchain has a distributed architecture, so that the first smart contract can be flexibly deployed on the first blockchain. For example, the first smart contract is deployed on a plurality of blockchain nodes corresponding to the first blockchain. When a blockchain node fails, execution of the first smart contract is not affected, so that robustness of a communication system can be improved.

In a possible embodiment, the first network function is configured to provide a subscription service, an authentication service, a registration service, a mobility management service, a policy management service, a data processing service, a charging service, a session management service, a computing service, a sensing service, or an AI service.

Based on the foregoing possible embodiment, at least one of the foregoing services may be deployed on a blockchain in a form of smart contract, to implement convergence of a blockchain network and the core network, and improve communication security.

In a possible embodiment, the first invocation request includes an identifier of the first smart contract and an input parameter of the first network function.

Based on the foregoing possible embodiment, a node that receives the first invocation request, for example, a first node, may determine to execute the first smart contract, and when executing the first smart contract, input the input parameter of the first network function into the first smart contract.

In a possible embodiment, the first invocation request further includes at least one of the following: an identifier of the first blockchain, information about an execution node of the first smart contract, information about a node on which the first smart contract is deployed, key information of the first smart contract, token access manner information of the first smart contract, version information of the first smart contract, or information about the first network function.

Based on the foregoing possible embodiment, the first invocation request may include at least one of the foregoing information. The identifier of the first blockchain may enable a node that receives the first invocation request, for example, a first node, to determine the blockchain on which the first smart contract is located, so as to determine a smart contract to be invoked by using the first invocation request. The information about the execution node of the first smart contract may enable a node that receives the first invocation request to determine specific execution nodes of the first smart contract, or determine whether the node is an execution node of the first smart contract. The information about the node on which the first smart contract is deployed may enable a node that receives the first invocation request to determine specific nodes on which the first smart contract is deployed, or determine whether the first smart contract is deployed on the node.

The key information of the first smart contract may include a public key or a public key certificate of the first smart contract, and may enable a node that receives the first invocation request to verify whether a third node is valid, to improve communication security. The token access manner information of the first smart contract may enable a node that receives the first invocation request to determine a token access manner of the first smart contract, for example, identifiers of smart contracts that can be accessed by the first smart contract, and/or validity periods of smart contracts that can be accessed by the first smart contract, to subsequently invoke these smart contracts. The version information of the first smart contract may enable a node that receives the first invocation request to determine a version of the first smart contract invoked by using the first invocation request, to perform comparison with a version of the first smart contract deployed on the node that receives the first invocation request, and determine whether the first invocation request can invoke the first smart contract deployed on the first node. The information about the first network function may enable a node that receives the first invocation request to determine a network function corresponding to the first smart contract.

In a possible embodiment, the first network function is an access function, a mobility management function, a network repository function, unified data management, an authentication server function, a session management function, a user plane function, a policy control function, a network exposure function, a computing plane function, a data plane function, or a smart plane function.

Based on the foregoing possible embodiment, the network function may be deployed on a blockchain in a form of smart contract, to implement convergence of a blockchain network and the core network, and improve communication security.

In a possible embodiment, the method further includes: receiving an execution result of the first smart contract.

Based on the foregoing possible embodiment, the execution result of the first smart contract may be obtained, to determine whether the first smart contract is successfully executed.

According to a fifth aspect, a communication apparatus is provided to implement the foregoing method. The communication apparatus may be the third node in the second aspect, or an apparatus including the third node, or a module, for example, a chip, a chip system, or a circuit, in the third node in the second aspect, or a logical node, a logical module, or a software embodiment that can implement some or all functions of the third node. Alternatively, the communication apparatus may be the first node in the third aspect, or an apparatus including the first node, or a module, for example, a chip, a chip system, or a circuit, in the first node in the third aspect, or a logical node, a logical module, or a software embodiment that can implement some or all functions of the first node. Alternatively, the communication apparatus may be the node that initiates service invocation in the fourth aspect, or an apparatus including the node that initiates service invocation, or a module, for example, a chip, a chip system, or a circuit, in the node that initiates service invocation in the fourth aspect, or a logical node, a logical module, or a software embodiment that can implement some or all functions of the node that initiates service invocation. The communication apparatus includes a corresponding module, unit, or means (means) for implementing the foregoing method. The module, unit, or means may be implemented by hardware, software, or hardware executing corresponding software. The hardware or the software includes one or more modules or units corresponding to the foregoing functions.

With reference to the fifth aspect, in a possible embodiment, the communication apparatus may include a processing module. The processing module may be configured to implement a processing function in any one of the foregoing aspects and any possible embodiment of the foregoing aspects. The processing module may be, for example, a processor.

With reference to the fifth aspect, in a possible embodiment, the communication apparatus may include an interface module. The interface module may also be referred to as an interface unit, and is configured to implement a sending function and/or a receiving function in any one of the foregoing aspects and any possible embodiment of the foregoing aspects. The interface module may include an interface circuit, a transceiver machine, a transceiver, or a communication interface.

With reference to the fifth aspect, in a possible embodiment, the interface module includes a sending module and a receiving module, respectively configured to implement the sending function and the receiving function in any one of the foregoing aspects and any possible embodiment of the foregoing aspects.

According to a sixth aspect, a communication apparatus is provided, including a processor. The processor is configured to: be coupled to a memory, and after reading instructions in the memory, perform the method in any one of the foregoing aspects according to the instructions. The communication apparatus may be the third node in the second aspect, or an apparatus including the third node, or a module, for example, a chip, a chip system, or a circuit, in the third node in the second aspect, or a logical node, a logical module, or a software embodiment that can implement some or all functions of the third node. Alternatively, the communication apparatus may be the first node in the third aspect, or an apparatus including the first node, or a module, for example, a chip, a chip system, or a circuit, in the first node in the third aspect, or a logical node, a logical module, or a software embodiment that can implement some or all functions of the first node. Alternatively, the communication apparatus may be the node that initiates service invocation in the fourth aspect, or an apparatus including the node that initiates service invocation, or a module, for example, a chip, a chip system, or a circuit, in the node that initiates service invocation in the fourth aspect, or a logical node, a logical module, or a software embodiment that can implement some or all functions of the node that initiates service invocation.

With reference to the sixth aspect, in a possible embodiment, the communication apparatus further includes the memory. The memory is configured to store program instructions and data.

With reference to the sixth aspect, in a possible embodiment, the communication apparatus is a chip or a chip system. Optionally, when the communication apparatus is the chip system, the communication apparatus may include a chip, or may include a chip and another discrete component.

According to a seventh aspect, a communication apparatus is provided, including a processor and an interface circuit. The interface circuit is configured to input and/or output signaling or data; and the processor is configured to enable, by using a logic circuit and/or executing a computer program or instructions, the communication apparatus to perform the method in any one of the foregoing aspects. The communication apparatus may be the third node in the second aspect, or an apparatus including the third node, or a module, for example, a chip, a chip system, or a circuit, in the third node in the second aspect, or a logical node, a logical module, or a software implementation that can implement some or all functions of the third node. Alternatively, the communication apparatus may be the first node in the third aspect, or an apparatus including the first node, or a module, for example, a chip, a chip system, or a circuit, in the first node in the third aspect, or a logical node, a logical module, or a software implementation that can implement some or all functions of the first node. Alternatively, the communication apparatus may be the node that initiates service invocation in the fourth aspect, or an apparatus including the node that initiates service invocation, or a module, for example, a chip, a chip system, or a circuit, in the node that initiates service invocation in the fourth aspect, or a logical node, a logical module, or a software implementation that can implement some or all functions of the node that initiates service invocation.

With reference to the seventh aspect, in a possible embodiment, the communication apparatus is a chip or a chip system. Optionally, when the communication apparatus is the chip system, the communication apparatus may include a chip, or may include a chip and another discrete component.

According to an eighth aspect, a non-transitory computer-readable storage medium is provided. The non-transitory computer-readable storage medium stores instructions. When the instructions are run on a computer, the computer is enabled to perform the method in any one of the foregoing aspects.

According to a ninth aspect, a computer program product including instructions is provided. When the computer program product runs on a computer, the computer is enabled to perform the method in any one of the foregoing aspects.

According to a tenth aspect, a communication system is provided. The communication system includes a first node configured to perform the method according to the third aspect, and a node that initiates service invocation and is configured to perform the method according to the fourth aspect.

For effects brought by any one of the possible embodiments in the fifth aspect to the tenth aspect, refer to the effects brought by any one of the first aspect to the fourth aspect or different possible embodiments in any aspect. Details are not described herein again.

The embodiments may be combined if the embodiments are not contradictory.

### BRIEF DESCRIPTION OF DRAWINGS

FIG. 1 is a diagram of an architecture of a core network;

FIG. 2 is a diagram in which a network function of a core network and/or a service function provided by the core network are/is deployed in a blockchain in a form of smart contract;

FIG. 3A is a diagram 1 of an architecture of a decentralized core network;

FIG. 3B is a diagram 2 of an architecture of a decentralized core network;

FIG. 3C is a diagram 3 of an architecture of a decentralized core network;

FIG. 4 is a diagram of a smart contract;

FIG. 5 is a diagram of a deployment manner of a smart contract having a network function;

FIG. 6 is a diagram of an architecture of a communication system;

FIG. 7 is a diagram of a hardware structure of a communication apparatus;

FIG. 8 is a schematic flowchart 1 of a service invocation method;

FIG. 9 is a schematic flowchart 2 of a service invocation method;

FIG. 10 is a schematic flowchart 3 of a service invocation method;

FIG. 11 is a schematic flowchart 4 of a service invocation method;

FIG. 12A is a diagram 1 of a deployment manner of a coordinator node;

FIG. 12B is a diagram 2 of a deployment manner of a coordinator node;

FIG. 12C is a diagram 3 of a deployment manner of a coordinator node; and FIG. 13 is a diagram of a structure of a communication apparatus.

### DETAILED DESCRIPTION OF EMBODIMENTS

Before the embodiments are described, related terms are described. The descriptions are intended to make the embodiments easier to understand, but should not be construed as a limitation on the scope of the embodiments.

### 1. Blockchain

The blockchain may also be referred to as a distributed ledger. Data may be generated and stored in blocks (or block-like), and connected into a chain (or chain-like) data structure in chronological order, and it is ensured in a cryptography manner that the data cannot be tampered with and cannot be forged. Any blockchain may be run (or deployed) on a plurality of blockchain nodes. In other words, one blockchain may be maintained by a plurality of blockchain nodes. For example, the plurality of blockchain nodes may share a ledger, and participate in operations such as transaction (transaction) on the blockchain and storage, verification, and forwarding of a block on the blockchain. When there is a newly created block in the blockchain, the block requires consensus confirmation from the plurality of blockchain nodes, and is broadcast in the blockchain to implement data synchronization between the blockchain nodes. Then, the block cannot be changed or deleted. Therefore, the blockchain has tamper-proofing.

The blockchain node may be a physical node (for example, a service node of a server, a cloud, or a data center) or a virtual node deployed on a physical node. If the blockchain node is a virtual node deployed on a physical node, a plurality of blockchain nodes that maintain one blockchain may be deployed on a same physical node or different physical nodes. For example, if a blockchain node 1 to a blockchain node n jointly maintain a blockchain A, the blockchain node 1 to the blockchain node n are all deployed on a server 1, or some blockchain nodes in the blockchain node 1 to the blockchain node n are deployed on a server 1, and the other blockchain nodes in the blockchain node 1 to the blockchain node n are deployed on a server 2.

A plurality of blockchains may form a blockchain network. In the blockchain network, each blockchain may be maintained by a plurality of blockchain nodes. Any blockchain node may maintain one or more blockchains. For example, the blockchain network includes a blockchain A and a blockchain B, a blockchain node 1 to a blockchain node 5 maintain the blockchain A, and a blockchain node 4 to a blockchain node 10 maintain the blockchain B. In other words, the blockchain node 1 to a blockchain node 3 maintain one blockchain (the blockchain A), and a blockchain node 6 to the blockchain node 10 maintain one blockchain (the blockchain B). The blockchain node 4 and the blockchain node 5 maintain two blockchains (the blockchain A and the blockchain B).

### 2. Smart Contract (SC)

Tamper-proofing, a consensus feature, a distributed feature, and the like of a blockchain spawn development of SC technologies. The SC is a computer protocol that can be deployed on a blockchain to propagate, verify, or execute a contract in an informatization manner. A corresponding operation can be performed by declaring service logic in the SC. The SC allows trusted transactions to be performed without a third party. These transactions are traceable and irreversible. The SC may be service logic that can be installed and run in a blockchain node, and is a segment of executable code. The executable code may be deployed at an account address on a blockchain by using a feature of the blockchain. When an invocation transaction is initiated to the address, the invocation transaction is verified in a blockchain network under the constraint of a consensus mechanism, and program code that is correspondingly invoked is executed, to ensure certainty and uniqueness of an execution result.

The blockchain may have a decentralization feature, so that program code constructed based on the SC can become a decentralized application (DAPP). Emergence of the DAPP changes an architecture of an internet application, so that deployment of the internet application gradually changes from centralization and a single service provider to a decentralized and distributed deployment and execution manner. Currently, there are already internet applications of several decentralized versions.

### 3. Terminal

The terminal may be a device having wireless receiving and sending functions. The terminal may be deployed on land, and include an indoor terminal, an outdoor terminal, a handheld terminal, or an in-vehicle terminal; or may be deployed on a water surface (for example, on a ship); or may be deployed in the air (for example, on an aircraft, a balloon, or a satellite). The terminal may also be referred to as a terminal device. The terminal device may be user equipment (UE), a mobile station (MS), a mobile terminal (MT), or the like, or may be a device configured to provide voice or data connectivity for a user. The UE includes a handheld device with a wireless communication function, a vehicle-mounted device (for example, on an automobile, a bicycle, an electric vehicle, an airplane, a ship, a train, or a high-speed train), a wearable device (for example, a smartwatch, a smart band, or a pedometer), or a compute device. For example, the UE may be a mobile phone, a tablet computer, a notebook computer, a palmtop computer, a mobile internet device (MID), a satellite terminal, or a computer with wireless receiving and sending functions. Alternatively, the terminal device may be a virtual reality (VR) terminal device, an augmented reality (AR) terminal device, a wireless modem, a smart point of sale (POS) terminal, customer-premises equipment (CPE), a smart robot, a mechanical arm, a workshop device, a smart home device (for example, a refrigerator, a television, an air conditioner, or an electric meter), a wireless terminal in industrial control, a wireless terminal in self-driving, a wireless terminal in telemedicine, a wireless terminal in a smart grid, a wireless terminal in transportation safety, a wireless terminal in a smart city, a wireless terminal in a smart home, a vehicle-mounted terminal, a road side unit (RSU) with a terminal function, a flight device (for example, a smart robot, a hot air balloon, an uncrewed aerial vehicle, or an airplane), or the like. Alternatively, the terminal device may be another device that has a terminal function. For example, the terminal device may be a device that functions as a terminal in device-to-device (D2D) communication.

The terminal may be a terminal in an internet of things (IoT) system. IoT is an important part of information technology development. An article in IoT may be connected to a network by using a communication technology, to implement an intelligent network of human-machine interconnection and interconnection between things. The terminal may be a terminal in machine type communication (MTC). The terminal may be a vehicle-mounted module, a vehicle-mounted component, a vehicle-mounted chip, or a vehicle-mounted unit that is built in a vehicle as one or more components or units. The vehicle may implement the method by using the built-in vehicle-mounted module, vehicle-mounted component, vehicle-mounted chip, or vehicle-mounted unit. The terminal may be a means of delivery, for example, a vehicle. Therefore, the embodiment may be applied to the internet of vehicles, for example, vehicle-to-everything (V2X), long term evolution-vehicle (LTE-V), and vehicle-to-vehicle (V2V).

A form of the terminal is not limited. An apparatus configured to implement a function of the terminal may be a terminal, or may be an apparatus, for example, a chip system, that can support the terminal in implementing the function. The apparatus can be installed in the terminal, or can match the terminal for use. The chip system may include a chip, or may include a chip and another discrete component.

### 4. Radio Access Network (RAN) Node

The RAN node may be any device having wireless receiving and sending functions, and may help a terminal implement radio access. For example, the RAN node is a node in a RAN, and may also be referred to as an access network device, a network device, or the like. The RAN node includes, but is not limited to: an evolved NodeB (eNB,) in long term evolution (LTE), an evolved NodeB in next generation LTE (ng-eNB), a base station gNB) in new radio (NR), a transmitting point (TP) or transmission reception point (TRP), a base station subsequently evolved in 3GPP, a next generation NodeB (gNB), a next generation NodeB in a 6th generation (6G) mobile communication system, a base station in a future mobile communication system, an access node in a satellite wireless fidelity (Wi-Fi) system, a wireless relay node, a wireless backhaul node, an integrated access and backhaul (IAB) node, a mobile switching center, or a network device in a non-terrestrial communication network (NTN) communication system, for example, may be deployed on a high-altitude platform, a satellite, or the like. The base station may be a macro base station, a micro base station, a pico base station, a small cell, a relay station, a donor node, a balloon station, or the like. A plurality of base stations may support networks of a same technology mentioned above, or may support networks of different technologies mentioned above. The base station may include one or more co-site or non-co-site TRPs. Alternatively, the RAN node may be a device that functions as a base station in D2D communication, internet of vehicles communication, uncrewed aerial vehicle communication, or machine communication. Alternatively, the RAN node may be a radio controller in a cloud radio access network (CRAN) scenario. Alternatively, the RAN node may be a central unit (CU), a distributed unit (DU), a CU-control plane (CP), a CU-user plane UP), a radio unit (RU), an RSU having a base station function, a wired access gateway, a core network element, or the like. Alternatively, the RAN node may be a server, a wearable device, a machine communication device, a vehicle-mounted device, or the like. For example, an access network device in a V2X technology may be an RSU.

The CU and the DU may be separately arranged, or may be included in a same network element, for example, a baseband unit (BBU). The RU may be included in a radio frequency device or a radio frequency unit, for example, included in a remote radio unit (RRU), an active antenna unit (AAU), or a remote radio head (RRH). The CU may be classified into a network device in an access network, or the CU may be classified into a network device in a core network. This is not limited herein.

In different systems, the CU (or the CU-CP and the CU-UP), the DU, or the RU may alternatively have different names, but a person skilled in the art may understand meanings thereof. For example, in an open radio access network (ORAN) system, the CU may alternatively be referred to as an open CU O_CU), the DU may alternatively be referred to as an O-DU, the CU-CP may alternatively be referred to as an O-CU-CP, the CU-UP may alternatively be referred to as an O-CU-UP, and the RU may alternatively be referred to as an O-RU. For ease of description, the CU, the CU-CP, the CU-UP, the DU, and the RU are used as examples for description. Any unit in the CU (or the CU-CP or the CU-UP), the DU, and the RU may be implemented by using a software module, a hardware module, or a combination of the software module and the hardware module.

In some scenarios, roles of the RAN node and the terminal are relative. For example, a helicopter or an uncrewed aerial vehicle that can be configured as a terminal may be alternatively configured as a mobile base station, and a device that accesses a RAN by using the helicopter or the uncrewed aerial vehicle is configured as a terminal.

A form of the RAN node is not limited. An apparatus configured to implement a function of the RAN node may be a RAN node, or may be an apparatus, for example, a chip system, that can support the RAN node in implementing the function. The apparatus can be installed in the RAN node, or can match the RAN node for use.

### 5. Core Network

The core network may be responsible for maintaining subscription data of a mobile network, and providing functions such as session management, mobility management, policy management, and security authentication for a terminal. The core network may be a centralized network architecture, and a network function (NF) of the core network is deployed by a management plane.

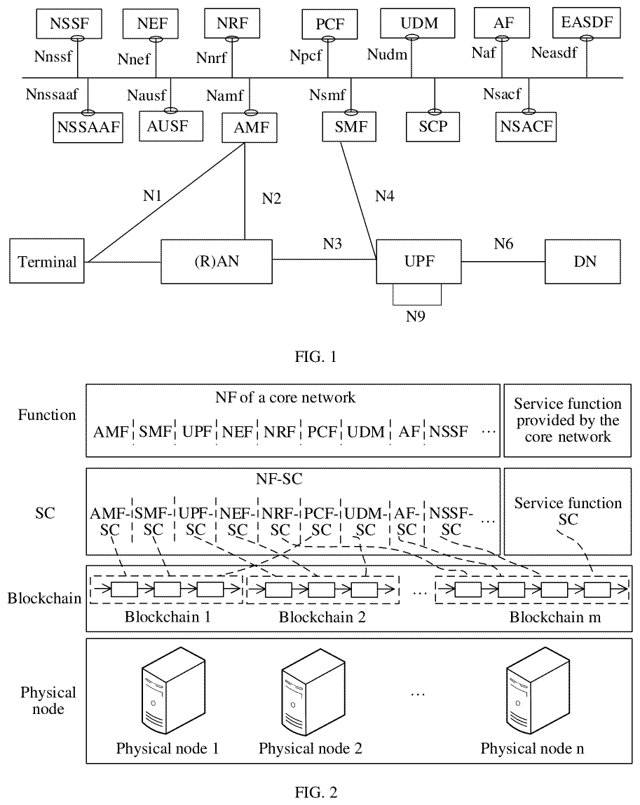

For example, FIG. 1 shows an architecture of a core network by using a network service architecture of a 5th generation (5G) mobile communication system as an example. In FIG. 1, network functions of the core network include a network slice selection function (NSSF), a network exposure function (NEF), a network repository function (NRF), a policy control function (PCF), unified data management (UDM), an application function (AF), an edge application server discovery function (EASDF), a network slice-specific and standalone non-public network (SNPN) network slice-specific and SNPN authentication and authorization function (NSSAAF), an authentication server function (AUSF), an access management function (AMF), a session management function (SMF), a service communication proxy (SCP), a network slice admission control function (NSACF), a user plane function (UPF), and a data network (DN). A RAN node may communicate with the AMF and the UPF, and a terminal may communicate with the AMF. The terminal and the RAN node may communicate with each other by using an air interface technology. For descriptions of the terminal and the RAN node, refer to the foregoing corresponding descriptions.

In FIG. 1, N1 is an interface between the terminal and the AMF, N2 is an interface between the RAN node and the AMF, N3 is an interface between the RAN node and the UPF, N4 is an interface between the SMF and the UPF, N6 is an interface between the UPF and the DN, and N9 is an interface between UPFs. Nnssaaf is a service-based interface provided by the NSSAAF, Nausf is a service-based interface provided by the AUSF, Namf is a service-based interface provided by the AMF, Nsmf is a service-based interface provided by the SMF, Nsacf is a service-based interface provided by the NSACF, Nnssf is a service-based interface provided by the NSSF, Nnef is a service-based interface provided by the NEF, Nnrf is a service-based interface provided by the NRF, Npcf is a service-based interface provided by the PCF, Nudm is a service-based interface provided by the UDM, Naf is a service-based interface provided by the AF, and Neasdf is a service-based interface provided by the EASDF.

The core network shown in FIG. 1 is merely an example. In specific application, the core network may include more or fewer network functions than those shown in FIG. 1. This is not limited.

Based on the foregoing descriptions, a blockchain has tamper-proofing. Therefore, to improve communication security between communication apparatuses in a communication system, and to support tracing and querying of behavior of the communication apparatuses and various types of data in the communication system, a solution of introducing a blockchain technology into the communication system (for example, a core network) is proposed in the industry. For example, information in the core network may be verified by using a blockchain.

For example, a blockchain account management function (BCAMF) network element may connect the core network and a blockchain network, to verify the information in the core network. A terminal may send a registration request message to a BCAMF network element of a first operator. The registration request message includes an identifier of the terminal, and the registration request message is used to request to register the terminal with the first operator. After receiving the registration request message from the terminal, the BCAMF network element may verify, in a blockchain based on the identifier of the terminal, that the terminal satisfies a registration requirement, and send a first message to a user data management network element of the first operator. The first message includes subscription data of the terminal, for example, subscription data of the terminal in the first operator. Then, the user data management network element may store the subscription data of the terminal, so that when the terminal subsequently accesses a mobile network of the first operator, a mobility management network element, a session management network element, or the like needs to obtain the subscription data to authorize the terminal.

It can be understood from the foregoing description that the BCAMF network element may verify, in the blockchain based on the identifier of the terminal, that the terminal satisfies the registration requirement, for example, the BCAMF network element can connect a core network and a blockchain network. However, in embodiments, the core network and the blockchain network are still networks independent of each other, and the blockchain network is only used to record data of the core network. This combination manner for the core network and the blockchain network cannot fully utilize advantages of the blockchain.

To more fully utilize the advantages of the blockchain, a decentralized core network may be constructed based on a distributed feature of the blockchain and with reference to a network function of the core network and/or a service function provided by the core network. The decentralized core network may use the blockchain as an infrastructure of the core network, to implement convergence of the blockchain network and the core network, for example, chain-network convergence. The network function of the core network and/or the service function provided by the core network may be deployed on the blockchain in a form of SC for invocation by an upper-layer application (APP), a terminal, a RAN node, an AF network element, a network function network element, or an operation, administration and maintenance (OAM) network element. After the function is invoked, the corresponding SC is executed, and an execution result is recorded on chain.

A “network obtained by converging the blockchain network and the core network” may be referred to as the “decentralized core network” merely for distinguishing from a “core network that is not converged with the blockchain network”, and is not intended to limit the solution of the embodiments. A manner of naming the “network obtained by converging the blockchain network and the core network” is not limited. For example, the decentralized core network may be replaced with a decentralized 3GPP network, a native decentralized core network, a native decentralized telecommunications network, a decentralized telecommunications network, a core network, a 3GPP network, a telecommunications network, a decentralized network, or the like. For ease of description, the decentralized core network is used as an example for description.

The following further explains and describes “the network function of the core network”, “the service function provided by the core network”, and “the network function of the core network and/or the service function provided by the core network are/is deployed on at least one blockchain in a form of SC”.

### 6. Network Function of a Core Network

The network function of the core network may include any one or more network functions defined in a current protocol, and/or a new network function introduced in a subsequent protocol. For example, the network function of the core network includes one or more network functions shown in FIG. 1. For another example, the network function of the core network includes a new network function introduced in a 6G communication technology.

### 7. Service Function Provided by a Core Network

The service function provided by the core network may include a service function of a third party, and/or a service function related to x as a service (XaaS). For example, the service function provided by the core network includes one or more of an internet of things service function, a satellite communication service function, a communication service function, a cloud service function, a network service function, an AI service, a computing service, or a data service.

8. a Network Function of a Core Network and/or a Service Function Provided by the Core Network are/is Deployed on at Least One Blockchain in a Form of SC.

The network function of the core network being deployed on the blockchain in a form of SC may involve the SC being deployed on the blockchain with the network function of the core network, or the SC that has the network function of the core network being installed (or deployed) on a blockchain node. For example, executable code that can implement the network function of the core network may be written, and the written executable code is deployed on the blockchain node. One network function may correspond to at least one SC. For example, when one network function is configured to implement one function (for example, a registration function), the network function may correspond to one SC, and the SC has the function; or the network function corresponds to a plurality of SCs, and the plurality of SCs jointly implement the function. When one network function is configured to implement a plurality of functions (for example, a registration function and a control plane signaling forwarding function), the network function may correspond to a plurality of SCs, and the plurality of SCs each have one function of the network function.

Similarly, the service function provided by the core network being deployed on the blockchain in a form of SC may be the SC being deployed on the blockchain has the service function provided by the core network, or the SC that has the service function provided by the core network is installed on a blockchain node. For example, executable code that can implement the service function provided by the core network may be written, and the written executable code is deployed on the blockchain node. When one service is configured to implement one function, the service function may correspond to one SC, and the SC has the function; or the service function corresponds to a plurality of SCs, and the plurality of SCs jointly implement the function. When one service is configured to implement a plurality of functions, the service function may correspond to a plurality of SCs, and the plurality of SCs each have one function of the service function.

Because the SC has the network function of the core network and/or the service function provided by the core network, the SC may be replaced with a network contract, a network SC, a network function contract, a network function smart contract (NF smart contract, NF-SC), a service contract, a service SC, a service function contract, a service function SC, or the like. In addition to the foregoing names, the SC may be further named in another manner, for example, a contract, a function contract, or a function SC. This is not limited. The SC is used as an example for description.

The following uses FIG. 2 as an example to describe a case in which a network function of a core network and/or a service function provided by the core network are/is deployed on a blockchain in a form of SC.

In FIG. 2, both the network function of the core network and the service function provided by the core network correspond to SCs. These SCs may be deployed on a blockchain, and the blockchain on which the SCs are deployed may be deployed on a physical node. An SC of an AMF (such as an AMF-SC), an SC of an SMF (such as an SMF-SC), and an SC of a PCF (such as a PCF-SC) are deployed on a blockchain 1, and the blockchain 1 is deployed on one or more physical nodes in a physical node 1 to a physical node n. An SC of a UPF (such as a UPF-SC), an SC of an NEF (such as an NEF-SC), and an SC of a UDM (a UDM-SC) are deployed on a blockchain 2, and the blockchain 2 is deployed on one or more physical nodes in the physical node 1 to the physical node n. An SC of an NRF (such as an NRF-SC), an SC of an NSSF (such as an NSSF-SC), an SC of an AF (such as an AF-SC), and an SC of the service function provided by the core network (such as a service function SC) are deployed on a blockchain m, and the blockchain m is deployed on one or more physical nodes in the physical node 1 to the physical node n. m and n are positive integers, and m and n may be the same or may be different.

The AMF-SC, the SMF-SC, and the PCF-SC are deployed on the blockchain 1, the UPF-SC, the NEF-SC, and the UDM-SC are deployed on the blockchain 2, and the NRF-SC, the NSSF-SC, the AF-SC, and the service function SC are deployed on the blockchain m above is merely a deployment manner of the SCs on the blockchains. The deployment manner of the SCs on the blockchains is not limited. For example, an SC may be deployed on a blockchain based on a service. For example, an SC related to a service 1 is deployed on a blockchain, and an SC other than the SC related to the service 1 is not deployed on the blockchain. For another example, an SC may be deployed on a blockchain based on a network function. For example, an SC of a network function 1 is deployed on a blockchain, and an SC of a service other than the network function 1 is not deployed on the blockchain. There may be other deployment manners, which are not listed one by one herein.

The following describes a decentralized core network with reference to an idea that “a network function of a core network and/or a service function provided by the core network are/is deployed on a blockchain in a form of SC”.

### 9. Decentralized Core Network

Based on the idea that “a network function of a core network and/or a service function provided by the core network are/is deployed on a blockchain in a form of SC”, a plurality of network architectures of the decentralized core network are possible, which cannot be listed one by one. The following embodiments are used as examples for description below. In addition, a manner in which the service function provided by the core network is deployed on a blockchain in a form of SC is similar to a manner in which the network function of the core network is deployed on a blockchain in a form of SC. Therefore, for ease of description, the following uses an example in which the network function of the core network is deployed on a blockchain in a form of SC for description. For a case in which the service function provided by the core network is deployed on a blockchain in a form of SC, refer to the following descriptions that the network function of the core network is deployed on a blockchain in a form of SC. Details are not described again.

Embodiment 1: One blockchain is deployed in a decentralized core network, and SCs corresponding to a plurality of network functions of the core network are deployed on the blockchain.

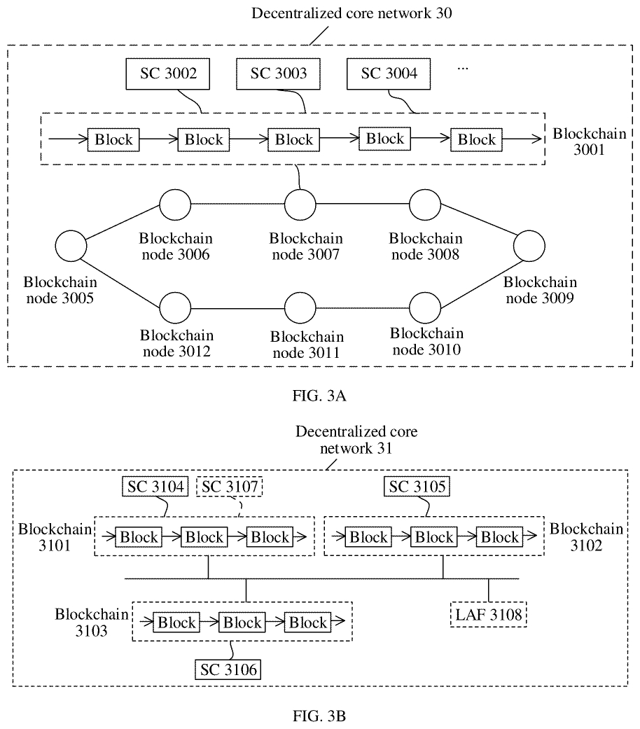

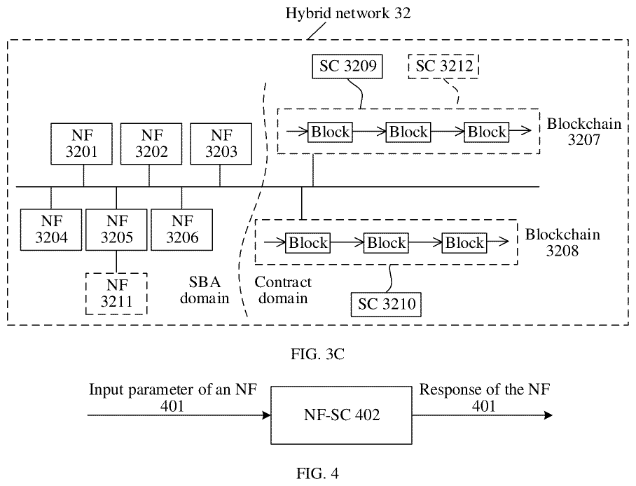

For example, in FIG. 3A, a blockchain 3001 is deployed in a decentralized core network 30, an SC 3002 to an SC 3004 are deployed on the blockchain 3001, and the blockchain 3001 is deployed on a blockchain node 3005 to a blockchain node 3012. In other words, the decentralized core network 30 includes the blockchain node 3005 to the blockchain node 3012, and these blockchain nodes jointly maintain the blockchain 3001 on which the SC 3002 to the SC 3004 are deployed. The SC 3002 to the SC 3004 each correspond to one network function of the core network. For example, the SC 3002 is an AMF-SC, the SC 3003 is an SMF-SC, and the SC 3004 is a UPF-SC.

Optionally, the decentralized core network 30 provides a ledger anchor function (LAF), configured to perform work related to a communication network ledger, for example, install or deploy an SC for a blockchain node. For example, the decentralized core network 30 includes an LAF network element (not shown in FIG. 3A).

A network including the blockchain node 3005 to the blockchain node 3012 may also be referred to as a P2P network. The blockchain node 3005 to the blockchain node 3012 may be deployed on a same physical node or different physical nodes.

FIG. 3A is merely an example of a decentralized core network. The decentralized core network may include more or fewer blockchain nodes than those shown in FIG. 3A, and/or more or fewer SCs than those shown in FIG. 3A may be deployed on the blockchain 3001. This is not limited.

In Embodiment 1, one blockchain may be deployed in the decentralized core network, so that the blockchain can be conveniently maintained.

Embodiment 2: A plurality of blockchains are deployed in a decentralized core network, and an SC corresponding to one or more network functions of the core network is deployed on each of the plurality of blockchains.

For example, in FIG. 3B, a blockchain 3101 to a blockchain 3103 are deployed in a decentralized core network 31. An SC 3104 and an SC 3107 are deployed on the blockchain 3101, an SC 3105 is deployed on the blockchain 3102, and an SC 3106 is deployed on the blockchain 3103. The SC 3104 to the SC 3107 each correspond to one network function of the core network. In other words, the decentralized core network 31 includes all or some blockchain nodes (not shown in FIG. 3B) that maintain the blockchain 3101 to the blockchain 3013. A blockchain node that maintains the blockchain 3101, a blockchain node that maintains the blockchain 3102, and a blockchain node that maintains the blockchain 3103 may be completely the same, partially the same, or completely different. For example, a blockchain node 1 to a blockchain node 5 jointly maintain the blockchain 3101 and the blockchain 3102, and a blockchain node 6 to a blockchain node 12 maintain the blockchain 3103; or a blockchain node 1 to a blockchain node 6 maintain the blockchain 3101, a blockchain node 7 to a blockchain node 13 maintain the blockchain 3102, and a blockchain node 14 to a blockchain node 22 maintain the blockchain 3103.

Optionally, the decentralized core network 31 provides an LAF, configured to perform work related to a communication network ledger, for example, install or deploy an SC for a blockchain node. For example, the decentralized core network 31 includes an LAF network element 3108.

Optionally, a plurality of SCs may be deployed on one blockchain in the decentralized core network 31. For example, in addition to the SC 3104, the SC 3107 is further deployed on the blockchain 3101.

FIG. 3B is merely an example of a decentralized core network. The decentralized core network may include more or fewer blockchains than those shown in FIG. 3B, and/or more or fewer SCs than those shown in FIG. 3B may be deployed on one blockchain. This is not limited.

In Embodiment 2, a plurality of blockchains are deployed in the decentralized core network, different SCs may be deployed on different blockchains, and a relatively small amount of data is stored on each blockchain. This facilitates data maintenance and management, and a relatively short time is needed for data tracing or querying.

In an evolution process of a network architecture, to consider an existing network and reduce network deployment costs, the network architecture can be gradually updated. For example, some network functions of a core network are first deployed on a blockchain in a form of SC, and then remaining network functions are gradually deployed on the blockchain in a form of SC. Therefore, in a network architecture update process, in the core network, there may be a case in which some network functions are still deployed in the network in a form of network function and the other network functions are deployed on a blockchain in a form of SC. This network architecture may be referred to as a hybrid networking architecture, a partially decentralized core network architecture, or the like. The following uses the hybrid networking architecture as an example for description.

Embodiment 3: At least one network function and at least one blockchain are deployed in a hybrid network, and an SC corresponding to one or more network functions of a core network is deployed on each of the at least one blockchain.

The hybrid network may be further divided into domains based on a deployment manner of the network function in the network. For example, the hybrid network includes a service-based architecture (SBA) domain and an SC domain, the at least one network function is deployed in the SBA domain, and the at least one blockchain is deployed in the SC domain. “Domain” may be replaced with “region”, “part”, “architecture”, or the like. This is not limited.

The SC domain may be related to a blockchain. Therefore, the SC domain may be replaced with a block domain, a blockchain domain, a blockchain node domain, or the like. This is not limited. In addition, a manner for connection between the SBA domain and the SC domain (or a manner for connection between a blockchain node and a network function network element) is not limited. For example, a newly defined interface may be used for connection.

For example, in FIG. 3C, an NF 3201 to an NF 3206 and a blockchain 3207 and a blockchain 3208 are deployed in the hybrid network 32. An SC 3209 is deployed on the blockchain 3207, and an SC 3210 is deployed on the blockchain 3208. The SC 3209 and the SC 3210 each correspond to one network function of the core network. In other words, the hybrid network 32 may include all or some blockchain nodes (not shown in FIG. 3C) that maintain the blockchain 3207 and the blockchain 3208. A blockchain node that maintains the blockchain 3207 and a blockchain node that maintains the blockchain 3208 may be completely the same, partially the same, or completely different.

Optionally, the hybrid network 32 provides an LAF, configured to perform work related to a communication network ledger, for example, install or deploy an SC for a blockchain node. In other words, the hybrid network 32 includes an LAF network element (not shown in FIG. 3C).

Optionally, a plurality of SCs may be deployed on one blockchain in the hybrid network 32. For example, in addition to the SC 3209, an SC 3212 is further deployed on the blockchain 3207.

FIG. 3C is merely an example of a hybrid network. The hybrid network may include more or fewer blockchains than those shown in FIG. 3C, and/or more or fewer network functions than those shown in FIG. 3C, and/or more or fewer SCs than those shown in FIG. 3C may be deployed on one blockchain. This is not limited.

Based on the foregoing descriptions, an embodiment may provide convergence of a blockchain network and a core network. In a converged network (for example, a decentralized core network), an SC has a network function of the core network. Details are described below.

In a possible embodiment, an input parameter of the network function is input into the SC corresponding to the network function (such as an NF-SC), to obtain a response of the network function or an output parameter of the network function.

A network function in the core network needs to obtain some parameters in advance when implementing a function of the network function, for example, a subscription permanent identifier (SUPI) of a terminal, a subscription concealed identifier (SUCI) of a terminal, or an identifier of a public land mobile network (PLMN). For example, when registering the terminal, an AMF needs to obtain the SUPI of the terminal in advance. These parameters may be referred to as input parameters of the network function. In addition, when implementing the function of the network function, the network function may obtain a corresponding output parameter based on the input parameter, for example, information such as the identifier of the PLMN, the SUPI of the terminal, the SUCI of the terminal, an identifier of the terminal in a 3GPP network, an authentication vector, or a key. For example, after completing registration of the terminal, the AMF allocates an identifier in a 3GPP network to the terminal. These output parameters may be referred to as responses of the network function. Because the SC has a network function, a corresponding response may be obtained by inputting an input parameter of the network function into the SC. For example, in FIG. 4, an input parameter of an NF 401 may be input into an SC corresponding to the NF 401 (such as an NF-SC 402), to obtain a response of the NF 401.

Optionally, a trigger condition and/or a response rule may be preset in the SC. The trigger condition may include a condition that is set for a time and/or an event and that triggers the SC to implement a corresponding network function. The response rule may define how the SC responds to different actions. Executable code for implementing the trigger condition may be written for the SC, so that the SC is executed or invoked under the trigger condition. Executable code for implementing the response rule may be written for the SC, so that the SC makes a corresponding response when being executed. Taking an SC corresponding to a charging function (CHF) as an example, a trigger condition thereof is that call duration of a user A is longer than 100 minutes, and a response rule thereof is that a corresponding call fee is deducted from an account of the user A. For example, when the call duration of the user A is longer than 100 minutes, execution of the SC is triggered. When the SC is executed, the corresponding call fee may be deducted from the account of the user A.

Optionally, because the SC is deployed on a blockchain, a trigger condition and/or a response rule for one or more blockchains or a trigger condition and/or a response rule for one or more SCs may be preset in the SC. For example, the following trigger condition is preset in an NF-SC 1 in a blockchain 1: After the NF-SC 1 is updated, a notification message is sent to a blockchain node in a blockchain 2. In this way, after the NF-SC 1 is updated, a blockchain node in the blockchain 1 may send the notification message to the blockchain node in the blockchain 2.

When providing a service, a core network may invoke one or more network functions. Based on this logic, when providing a service, a decentralized core network may invoke one or more SCs. There is a specific invocation sequence or execution sequence between the invoked SCs, which may be referred to as an SC chain (SC chain). The following describes the SC chain in detail.

### 10. SC Chain

The SC chain may include at least one SC that needs to be invoked when a decentralized core network processes a service (or a service). There is a specific invocation sequence or execution sequence between the at least one SC. Different services may correspond to different SC chains. That two SC chains are different may be two SC chains that differ in terms of at least one included SC, or SC invocation sequences or execution sequences are different.

The decentralized core network may process various services, including a service that can be processed by the core network, and/or a new service that emerges in a network evolution process. In the embodiments, a terminal (UE) registration request service, a terminal service request service, a terminal (UE) configuration update service, an AF service request service, an AN release request service, an SMF service context transfer procedure service, and a network slice-specific authentication and authorization service are used as examples to describe the SC chain.

For example, an SC chain of the terminal registration request service includes AMF-SC=>AUSF-SC=>UDM-SC. For example, after a terminal initiates a terminal registration request to a decentralized core network through a RAN node, the decentralized core network first invokes the AMF-SC, the AMF-SC invokes the AUSF-SC, and the AUSF-SC invokes the UDM-SC, to register the terminal with the decentralized core network.

For example, an SC chain of the terminal service request service includes AMF-SC=>AUSF-SC=>AMF-SC=>SMF-SC=>UPF-SC=>SMF-SC=>AMF-SC, UPF-SC, and AMF-SC=>SMF-SC=>PCF-SC=>SMF-SC=>UPF-SC=>SMF-SC. For example, after a terminal initiates a terminal service request to a decentralized core network through a RAN node, the decentralized core network first invokes the AMF-SC, the AMF-SC invokes the AUSF-SC, the AUSF-SC returns an execution result (or an invocation result) to the AMF-SC, the AMF-SC invokes the SMF-SC, the SMF-SC invokes the UPF-SC, the UPF-SC returns the execution result to the SMF-SC, and the SMF-SC returns the execution result to the AMF-SC. The AMF-SC sends the execution result to the terminal through the RAN node. Subsequently, the terminal triggers the decentralized core network to invoke the UPF-SC, the RAN node triggers the decentralized core network to invoke the AMF-SC, the AMF-SC invokes the SMF-SC, the SMF-SC invokes the PCF-SC, the PCF-SC returns the execution result to the SMF-SC, the SMF-SC invokes the UPF-SC, and the UPF-SC returns the execution result to the SMF-SC, to provide a service requested by the terminal.

For example, an SC chain of the terminal configuration update service includes AM-SC and AMF-SC=>UDM-SC=>AMF-SC. For example, after a terminal initiates a terminal configuration update request to a decentralized core network through a RAN node, the decentralized core network invokes the AMF-SC, and the AMF-SC returns an execution result to the terminal through the RAN node. Then, the terminal initiates a request to the decentralized core network through the RAN node based on the execution result, the decentralized core network invokes the AMF-SC, the AMF-SC invokes the UDM-SC, the UDM-SC returns the execution result to the AMF-SC, and the AMF-SC returns the execution result to the RAN node, to update a terminal configuration.

For example, an SC chain of the AF service request service includes NEF-SC=>UDM-SC. For example, after an AF network element initiates a service request to a decentralized core network, the decentralized core network invokes the NEF-SC, and the NEF-SC invokes the UDM-SC to provide a service for the AF network element.

For example, an SC chain of the AN release request service includes AMF-SC or AMF-SC=>SMF-SC=>UPF-SC. For example, after a terminal initiates an AN release request to a decentralized core network through a RAN node, the decentralized core network invokes the AMF-SC to release an AN. Alternatively, after a terminal initiates an AN release request to a decentralized core network through a RAN node, the decentralized core network invokes the AMF-SC, the AMF-SC invokes the SMF-SC, and the SMF-SC invokes the UPF-SC to release an AN.

For example, an SC chain of the SMF service context transfer procedure service includes SMF-SC 1=>SMF-SC 2. For example, when processing the SMF service context transfer procedure service, a decentralized core network uses the SMF-SC 1 as a consumer of a network function service, and pushes a session management (session management, SM) context to the SMF-SC 2 as a producer of the network function service.

For example, an SC chain of the network slice-specific authentication and authorization service includes AMF-SC and AMF-SC=>NSSAAF-SC. For example, after a terminal initiates a network slice-specific authentication and authorization request to a decentralized core network through a RAN node, the decentralized core network invokes the AMF-SC, and the AMF-SC returns an execution result to the terminal. Then, the terminal initiates a request to the decentralized core network, the decentralized core network invokes the AMF-SC, and the AMF-SC invokes the NSSAAF-SC. Then, the NSSAAF-SC may send the execution result to an authentication, authorization, and accounting, server (AAA-S) through an AAA proxy, to implement network slice-specific authentication and authorization.

The foregoing describes the SC chain by using the decentralized core network as an example. The SC chain is also applicable to hybrid networking. In hybrid networking, when providing a service, a network may invoke at least one SC and/or at least one network function. For example, in hybrid networking, when providing a service, a network may invoke not only an SC but also a network function. Therefore, in hybrid networking, the SC chain may be replaced with a function chain. For example, for the terminal registration request service, one or more of the AMF-SC, the AUSF-SC, and the UDM-SC may be replaced with a corresponding network function. For example, an AMF is deployed in a hybrid network in a form of SBA, and an AUSF and a UDM are deployed in the hybrid network in a form of SC. The AMF-SC may be replaced with the AMF. In other words, after the hybrid network receives a terminal registration request, an AMF network element performs corresponding processing and invokes the AUSF-SC, and the AUSF-SC invokes the UDM-SC. Therefore, a function chain of the terminal registration request service includes AMF=>AUSF-SC=>UDM-SC. The following service invocation method is described by using an SC chain as an example. The service invocation method may also be applicable to a function chain. Logic of processing the function chain by the hybrid network is similar to logic of processing the SC chain by the decentralized core network. For details, refer to related descriptions of processing the SC chain by the decentralized core network. Details are not described again.

### 11. Deployment Manner of an SC on a Blockchain

The SC is a segment of executable code used to implement a network function. Therefore, the SC being deployed on the blockchain may involve the SC being installed/deployed on a blockchain node. The blockchain node may have a running environment of the SC.

The SC may be installed on a plurality of blockchain nodes, but not all the blockchain nodes are nodes that execute (or run) the SC. For example, some of the plurality of blockchain nodes are execution nodes of the SC, and the other blockchain nodes are verification nodes of the SC and are configured to verify an execution result of the SC, to ensure correctness of the execution result of the SC. A quantity of execution nodes of the SC is greater than or equal to 1, and a quantity of verification nodes of the SC is greater than or equal to 1.

The SC may be installed on a plurality of blockchain nodes of one blockchain, or on a plurality of blockchain nodes of a plurality of blockchains. This is not limited.

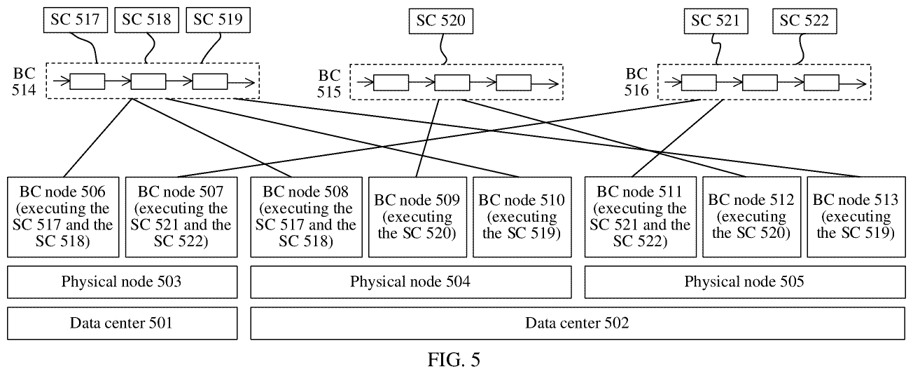

For example, FIG. 5 is a diagram of a deployment manner of an SC. In FIG. 5, an SC 517, an SC 518, and an SC 519 are deployed on a blockchain (BC) 514, and the blockchain 514 is deployed on a blockchain node 506, a blockchain node 508, a blockchain node 510, and a blockchain node 513. In other words, the SC 517, the SC 518, and the SC 519 are installed on the blockchain node 506, the blockchain node 508, the blockchain node 510, and the blockchain node 513. However, not all of the foregoing blockchain nodes are execution nodes of the SC 517, the SC 518, and the SC 519.

For example, in the figure, execution nodes of the SC 517 and the SC 518 are the blockchain node 506 and the blockchain node 508, and execution nodes of the SC 519 are the blockchain node 510 and the blockchain node 513. An SC 520 is deployed on a blockchain 515, and the blockchain 515 is deployed on a blockchain node 509 and a blockchain node 512. In other words, the SC 520 is installed on the blockchain node 509 and the blockchain node 512. In FIG. 5, both the blockchain node 509 and the blockchain node 512 are execution nodes of the SC 520. An SC 521 and an SC 522 are deployed on a blockchain 516, and the blockchain 516 is deployed on a blockchain node 507 and a blockchain node 511. In other words, the SC 521 and the SC 522 are installed on the blockchain node 507 and the blockchain node 511. In FIG. 5, both the blockchain node 507 and the blockchain node 511 are execution nodes of the SC 521 and the SC 522.

A blockchain node may be deployed on a physical node, and the physical node may be deployed in a data center. For example, in FIG. 5, the blockchain node 506 and the blockchain node 507 are deployed on a physical node 503, and the physical node 503 is deployed in a data center 501. The blockchain node 508 to the blockchain node 510 are deployed on a physical node 504, the blockchain node 511 to the blockchain node 513 are deployed on a physical node 505, and the physical node 504 and the physical node 505 are deployed in a data center 502.

If an SC is installed on a blockchain node, the blockchain node (or a blockchain maintained by the blockchain node) stores information about the SC.

The information about the SC may include an identifier of the SC. The identifier of the SC may indicate the SC, and for example, is an SC ID or an internet protocol (IP) address of the SC.

Optionally, the information about the SC further includes at least one of the following: an identifier of a blockchain on which the SC is located, information about an execution node of the SC, information about a verification node of the SC, information about a node on which the SC is deployed, key information of the SC, token access manner information of the SC, version information of the SC, an input parameter of a network function of the SC, or information about a network function of the SC.

The identifier of the blockchain on which the SC is located indicates the blockchain on which the SC is located or the blockchain on which the SC is deployed, and for example, is an ID of the blockchain. The information about the execution node of the SC indicates the execution node of the SC. For example, the information about the execution node of the SC includes an identifier of the execution node of the SC or an IP address of the execution node of the SC. The information about the verification node of the SC indicates the verification node of the SC. For example, the information about the verification node of the SC includes an identifier of the verification node of the SC or an IP address of the verification node of the SC. The information about the node on which the SC is deployed indicates the node on which the SC is deployed (or installed).

For example, the information about the node on which the SC is deployed includes an identifier of the node on which the SC is deployed (or installed), or an IP address of the node on which the SC is deployed (or installed). The key information of the SC includes one or more of a public key of the SC, a public key certificate of the SC, or a private key of the SC. The token access manner information of the SC indicates a token access manner of the SC. The token access manner information of the SC includes an identifier of an SC that can be accessed by the SC. Optionally, the token access manner information of the SC includes a validity period for access by the SC. The version information of the SC indicates a version of the SC. For example, the version information of the SC includes a version number of the SC. The information about the network function of the SC indicates the network function of the SC. For example, the information about the network function of the SC includes an identifier of the network function of the SC or an interface provided by the network function of the SC. The information about the network function of the SC may further include a number segment of a terminal supported by the network function of the SC, and/or location information of the network function of the SC. The identifier of the SC and the token access manner information of the SC may be referred to as an account of the SC.

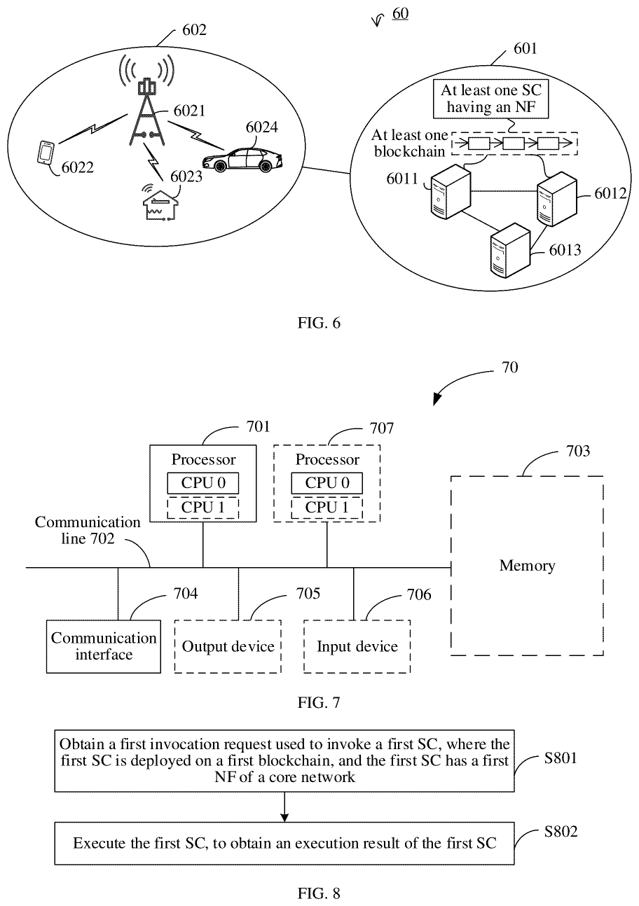

The foregoing describes a decentralized core network and an SC deployed in the core network. In the foregoing decentralized core network, a network function of the core network is deployed on a blockchain in a form of SC. Based on this idea, the embodiment further provides a communication system. The communication system can implement convergence of a blockchain network and a core network. The communication system is applicable to various communication scenarios. For example, the communication system is a long term evolution (LTE) system, a 5th generation (5G) communication system, a wireless fidelity (Wi-Fi) system, a communication system related to the 3rd generation partnership project (3GPP), a communication system evolved after 5G (for example, a 6G communication system), or a system obtained by combining a plurality of systems. This is not limited. 5G may also be referred to as new radio (NR). The following uses a communication system 60 shown in FIG. 6 as an example for description. FIG. 6 is merely a diagram, and does not constitute a limitation on a scenario to which the embodiments are applicable.

The communication system 60 shown in FIG. 6 includes at least two nodes that are communicatively connected, for example, a node 6011 and a node 6012. The at least two nodes maintain at least one blockchain, and at least one SC that has a network function is deployed on the at least one blockchain. Optionally, the at least two nodes are blockchain nodes. A manner for connection between the at least two nodes is not limited. For example, the at least two nodes may be connected in a wired or wireless manner. The wireless manner includes a communication manner such as 3G, 4G, 5G, or 6G.

Optionally, a network function of a core network is configured to provide at least one of the following services: a subscription service, an authentication service, a registration service, a mobility management service, a policy management service, a data processing service, a charging service, a session management service, or at least one service that can be provided by a core network (for example, a 6G core network) after 5G. For example, the core network after 5G can provide at least one of the following services: a computing service, a sensing service, or an AI service. The foregoing services are merely examples of services provided by the network function of the core network. The network function of the core network may provide more or fewer services than the foregoing services. This is not limited.

For example, the network function of the core network includes at least one of the following: an access function, a mobility management function, a network repository function, unified data management, an authentication server function, a session management function, a user plane function, a policy control function, a network exposure function, a computing plane function (for example, a computing plane function in a 6G core network), a data plane function (for example, a data plane function in a 6G core network), or a smart plane function (for example, a smart plane function in a 6G core network). For example, the network function of the core network includes at least one of the following: an AMF, an NRF, a UDM, an AUSF, an SMF, a UPF, a PCF, an NEF, or a function corresponding to a network function that emerges after 5G.

The communication system 60 may be applied to the foregoing decentralized core network or hybrid network. In other words, a network 601 in which the at least two nodes are located is the foregoing decentralized core network or hybrid network. The following separately describes a specific case in which the communication system 60 is applied to the decentralized core network or the hybrid network in two cases: a case in which the at least two nodes jointly maintain one blockchain and a case in which the at least two nodes respectively maintain different blockchains.

Case 1: The at least two nodes jointly maintain one blockchain.

In a possible embodiment, the at least one blockchain includes a first blockchain, the node 6011 and the node 6012 jointly maintain the first blockchain, a first SC and a second SC are deployed on the first blockchain, the first SC has a first network function of the core network, and the second SC has a second network function of the core network.

For example, the network 601 in which the at least two nodes are located is the foregoing decentralized core network 30. The node 6011 and the node 6012 are any two blockchain nodes in the decentralized core network 30. For example, the node 6011 is the blockchain node 3007, and the node 6012 is the blockchain node 3008. The first blockchain is the blockchain 3001, and the first SC and the second SC are any two SCs in the SC 3002 to the SC 3004. For example, the first SC is the SC 3002, and the second SC is the SC 3004.

Optionally, the communication system 60 (or the network 601) further includes a network element (not shown in FIG. 6) of the core network that is communicatively connected to the at least two nodes. The network element of the core network is configured to invoke the SC deployed on the at least one blockchain, or the network element of the core network is configured to provide a service for the SC deployed on the at least one blockchain.

For example, the network 601 in which the at least two nodes are located is the foregoing hybrid network 32. The network element of the core network includes a network element of at least one NF in the NF 3201 to the NF 3206 and an NF 3211. The node 6011 and the node 6012 are blockchain nodes that maintain the blockchain 3207. The first blockchain is the blockchain 3207, the first SC is the SC 3209, and the second SC is the SC 3212. The network element of the core network may invoke the SC 3209 and/or the SC 3212, or the network element of the core network may provide a service for the SC 3209 and/or the SC 3212.

In case 1, information about the first SC is stored on the first blockchain, or information about the first SC is stored on the node 6011 and the node 6012. The information about the first SC includes an identifier of the first SC. Optionally, the information about the first SC further includes at least one of the following: an identifier of the first blockchain, information about an execution node of the first SC, information about a node on which the first SC is deployed, key information of the first SC, token access manner information of the first SC, version information of the first SC, an input parameter of the first network function, or information about the first network function. For specific descriptions of the foregoing information, refer to the foregoing descriptions of the information about the SC.

Case 2: The at least two nodes maintain different blockchains.

In a possible embodiment, the at least one blockchain includes a first blockchain and a second blockchain, the node 6011 maintains the first blockchain, the node 6012 maintains the second blockchain, a first SC is deployed on the first blockchain, a second SC is deployed on the second blockchain, the first SC has a first network function of the core network, and the second SC has a second network function of the core network.

For example, the network 601 in which the at least two nodes are located is the foregoing decentralized core network 31. The node 6011 is a blockchain node that maintains the blockchain 3101, and the node 6012 is a node that maintains the blockchain 3102. The first blockchain is the blockchain 3101, the second blockchain is the blockchain 3102, the first SC is the SC 3104 or the SC 3107, and the second SC is the SC 3105.

Optionally, the communication system 60 (or the network 601) further includes a network element (not shown in FIG. 6) of the core network that is communicatively connected to the at least two nodes. The network element of the core network is configured to invoke the SC deployed on the at least one blockchain, or the network element of the core network is configured to provide a service for the SC deployed on the at least one blockchain.

For example, the network 601 in which the at least two nodes are located is the foregoing hybrid network 32. The network element of the core network includes a network element of at least one NF in the NF 3201 to the NF 3206 and an NF 3211. The node 6011 is a blockchain node that maintains the blockchain 3207, the node 6012 is a blockchain node that maintains the blockchain 3208, the first blockchain is the blockchain 3207, the second blockchain is the blockchain 3208, the first SC is the SC 3209, and the second SC is the SC 3210. The network element of the core network may invoke the SC 3209 and/or the SC 3210, or the network element of the core network may provide a service for the SC 3209 and/or the SC 3210.

In case 2, information about the first SC is stored on the first blockchain, or information about the first SC is stored on the node 6011. Information about the second SC is stored on the second blockchain, or information about the second SC is stored on the node 6012. The information about the first SC includes an identifier of the first SC. Optionally, the information about the first SC further includes at least one of the following: an identifier of the first blockchain, information about an execution node of the first SC, information about a node on which the first SC is deployed, key information of the first SC, token access manner information of the first SC, version information of the first SC, an input parameter of the first network function, or information about the first network function. The information about the second SC includes an identifier of the second SC. Optionally, the information about the second SC further includes at least one of the following: an identifier of the second blockchain, information about an execution node of the second SC, information about a node on which the second SC is deployed, key information of the second SC, token access manner information of the second SC, version information of the second SC, an input parameter of the second network function, or information about the second network function.

For the foregoing case 1 and case 2, the communication system 60 may further have the following feature.

In a possible embodiment, the communication system 60 further includes a RAN 602 connected to the network 601. The RAN 602 may be a 3GPP-related cellular system, for example, a 3G, 4G, or 5G mobile communication system, or an evolved system (for example, a 6G mobile communication system) after 5G. The RAN 602 may alternatively be an ORAN, a CRAN, or a Wi-Fi system. The RAN 602 may alternatively be a communication system obtained by combining two or more of the foregoing systems.

The RAN 602 includes at least one RAN node (FIG. 6 shows one RAN node 6021). The RAN 602 further includes at least one terminal (FIG. 6 shows three terminals, which are respectively a terminal 6022 to a terminal 6024). In FIG. 6, the terminal may be connected to the RAN node 6021 in a wireless manner. The RAN node 6021 may also be referred to as an access network device, a RAN entity, an access node, or the like sometimes, and constitutes a part of the communication system, to help the terminal implement radio access. The RAN node 6021 may be communicatively connected to at least one node in the network 601. For example, if the network 601 is the foregoing decentralized core network 30, the RAN node 6021 may be connected to at least one blockchain node in the decentralized core network 30. For example, the RAN node 6021 is connected to the blockchain node 3008. If the network 601 is the foregoing decentralized core network 31, the RAN node 6021 may be connected to at least one blockchain node in the decentralized core network 31. For example, the RAN node 6021 is connected to a blockchain node on which an AMF-SC and/or a UPF-SC are/is installed. For example, the SC 3104 is the AMF-SC, and the SC 3105 is the UPF-SC. The RAN node 6021 is connected to a blockchain node that maintains the blockchain 3101 and/or a blockchain node that maintains the blockchain 3102. If the network 601 is the foregoing hybrid network 32, the RAN node 6021 may be connected to at least one network element or at least one blockchain node in the hybrid network 32. The RAN node 6021 may be connected to an AMF network element and a UPF network element. For example, the NF 3204 is an AMF, and the NF 3211 is a UPF. The RAN node 6021 is connected to a network element in which the NF 3204 is located and a network element in which the NF 3211 is located. Alternatively, the RAN node 6021 is connected to a blockchain node on which an AMF-SC and a UPF-SC are installed. For example, the SC 3209 is the AMF-SC, and the SC 3212 is the UPF-SC. The RAN node 6021 is connected to a blockchain node that maintains the blockchain 3207. Alternatively, the RAN node 6021 is connected to a UPF network element and a blockchain node on which an AMF-SC is installed. For example, the NF 3211 is a UPF, and the SC 3210 is the AMF-SC. The RAN node 6021 is connected to a network element in which the NF 3211 is located and a blockchain node that maintains the blockchain 3208.

The RAN node and/or the terminal may be configured to invoke the SC deployed on the at least one blockchain. In other words, the RAN node and/or the terminal have/has a capability of invoking an SC in a blockchain. For a specific invocation method, refer to corresponding descriptions in the following methods shown in FIG. 8 to FIG. 11. For other descriptions of the terminal and the RAN node, refer to the foregoing descriptions of the terminal and the RAN node. Details are not described again.

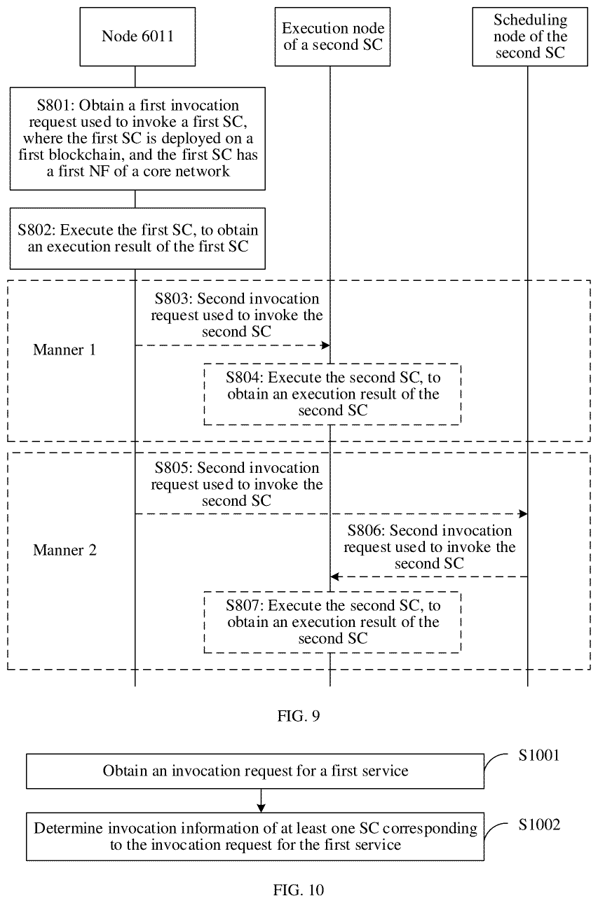

In a possible embodiment, any one of the at least two nodes is configured to receive an invocation request for an SC, to implement invocation of the SC. The invocation request for the SC is from one or more of a terminal, a RAN node, an AF network element, a network function network element, or an OAM network element. This process is described in the following method shown in FIG. 8 and FIG. 9.

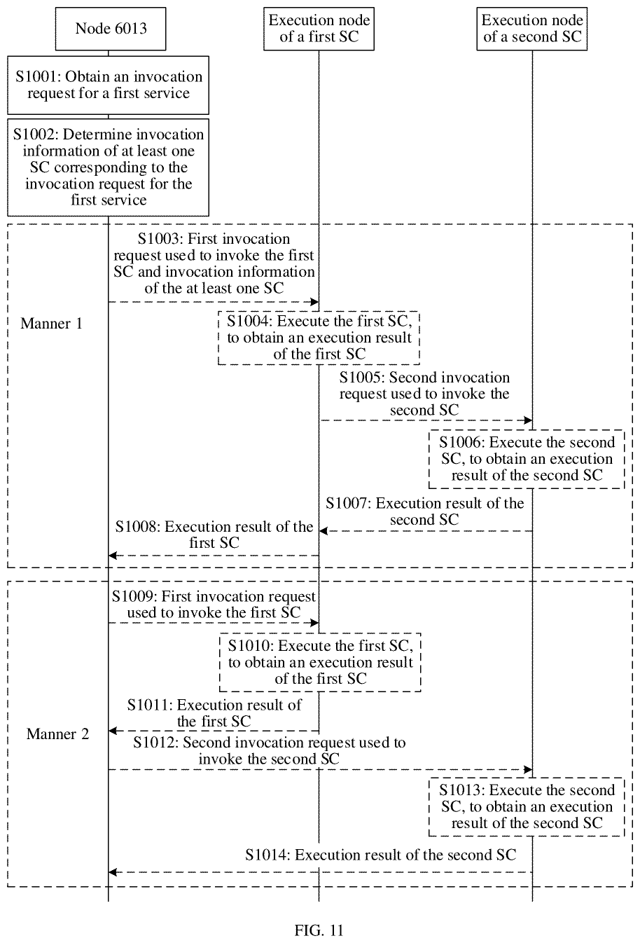

In a possible embodiment, the communication system 60 further includes a node 6013. The node 6013 is configured to parse an invocation request for a service, to obtain invocation information of at least one SC corresponding to the invocation request for the service, so as to implement service invocation by invoking the at least one SC. The invocation request for the service is from one or more of a terminal, a RAN node, an AF network element, a network function network element, or an OAM network element. This process is described in the following method shown in FIG. 10 and FIG. 11. Optionally, the node 6013 and the node 6011 are deployed on a same physical node or different physical nodes; or the node 6013 and the node 6012 are deployed on a same physical node or different physical nodes.

In a possible embodiment, the communication system 60 further includes at least one scheduling node (not shown in FIG. 6). Any scheduling node is configured to schedule the at least one SC. For example, the network 601 is the foregoing decentralized core network 31. The decentralized core network 31 further includes a scheduling node 1 and a scheduling node 2 (not shown in FIG. 3B). The scheduling node 1 is configured to schedule the SC 3104, the SC 3107, and the SC 3105, and the scheduling node 2 is configured to schedule the SC 3106. Therefore, a node that initiates invocation of the SC 3104 may first send a request for invoking the SC 3104 to the scheduling node 1. After receiving the request, the scheduling node 1 sends the request to an execution node of the SC 3104, for example, a node that maintains the blockchain 3101, to invoke the SC 3104. A node that initiates invocation of the SC 3106 may first send a request for invoking the SC 3106 to the scheduling node 2. After receiving the request, the scheduling node 2 sends the request to an execution node of the SC 3106, for example, a node that maintains the blockchain 3103, to invoke the SC 3106.

Based on the idea that a network function of a core network is deployed on a blockchain in a form of SC, a function of the terminal, and/or a function of the RAN node, and/or the OAM network element may also be deployed on the blockchain in a form of SC. For example, the function of the RAN node is deployed on the blockchain in a form of SC. The RAN node 6021 may be replaced with at least one blockchain node. At least one SC is installed on the at least one blockchain node, and the at least one SC has a function of the RAN node 6021. The terminal or the network 601 may communicate with the at least one blockchain node, to invoke the at least one SC.

The communication system 60 may be a new network architecture. How to invoke a service in this new network architecture is a problem to be resolved. Therefore, the embodiment further provides a service invocation method. According to the method, the node 6011 or the node 6012 may obtain an invocation request, and invoke an SC on a blockchain based on the invocation request to implement a corresponding network function. The method is described in the following method shown in FIG. 8 and FIG. 9. Alternatively, the node 6013 may obtain an invocation request for a service, and determine invocation information of at least one SC corresponding to the invocation request, so as to invoke the service by invoking the at least one SC. The method is described in the following method shown in FIG. 10 and FIG. 11.

The communication system 60 shown in FIG. 6 is merely used as an example, and is not intended to limit the embodiments. A person skilled in the art should understand that, during specific implementation, the communication system 60 may further include another device, and a quantity of RAN nodes, terminals, core network elements, or blockchain nodes may be determined according to a specific requirement. This is not limited.

Optionally, each network element or device (for example, the RAN node 6021, the terminal, and the node 6011 to the node 6013) in FIG. 6 may also be referred to as a communication apparatus, and may be a general-purpose device or a dedicated device. This is not limited.

Optionally, a related function of each network element or device (for example, the RAN node 6021, the terminal, and the node 6011 to the node 6013) in FIG. 6 may be implemented by one device, or may be jointly implemented by a plurality of devices, or may be implemented by one or more functional modules in one device. This is not limited. The foregoing function may be an element in a hardware device, or may be a software function running on dedicated hardware, a combination of hardware and software, or a virtualization function instantiated on a platform (for example, a cloud platform).

During specific implementation, each network element or device (for example, the RAN node 6021, the terminal, and the node 6011 to the node 6013) in FIG. 6 may use a composition structure shown in FIG. 7, or include a component shown in FIG. 7. FIG. 7 is a diagram of a hardware structure of a communication apparatus to which the embodiment is applicable. The communication apparatus 70 includes at least one processor 701 and at least one communication interface 704, to implement the method. The communication apparatus 70 may further include a communication line 702 and a memory 703.

The processor 701 may be a general-purpose central processing unit (CPU), a microprocessor, an application-specific integrated circuit (ASIC), or one or more integrated circuits configured to control program execution in the embodiments.

The communication line 702 may include a path for transferring information between the foregoing components, for example, a bus.

The communication interface 704 is configured to communicate with another device or a communication network. The communication interface 704 may be any apparatus like a transceiver, for example, may be an Ethernet interface, a radio access network (RAN) interface, a wireless local area network (WLAN) interface, a transceiver, a pin, a bus, an interface circuit, or a transceiver circuit.

The memory 703 may be a read-only memory (ROM) or another type of static storage device capable of storing static information and instructions, or may be a random access memory (RAM) or another type of dynamic storage device capable of storing information and instructions, or may be an electrically erasable programmable read-only memory (EEPROM), a compact disc read-only memory (CD-ROM) or other compact disc storage, optical disc storage (including a compressed optical disc, a laser disc, an optical disc, a digital versatile disc, a Blu-ray disc, or the like), a magnetic disk storage medium or another magnetic storage device, or any other medium capable of carrying or storing expected program code in a form of an instruction or a data structure and capable of being accessed by a computer. However, this is not limited. The memory may exist independently, and is coupled to the processor 701 through the communication line 702. The memory 703 may be alternatively integrated with the processor 701. The memory may be non-volatile.

The memory 703 is configured to store computer-executable instructions for performing the embodiments, and the processor 701 controls execution. The processor 701 is configured to execute the computer executable instructions stored in the memory 703, to implement a method. Alternatively, optionally, in the embodiments, the processor 701 may perform a processing-related function in a method provided below, and the communication interface 704 is responsible for communicating with another device or a communication network. This is not limited.

Optionally, the computer-executable instructions may also be referred to as application program code. This is not limited.

The coupling may be an indirect coupling or a communication connection between apparatuses, units, or modules, may be in an electrical form, a mechanical form, or another form, and is used for information exchange between the apparatuses, the units, or the modules.

In an embodiment, the processor 701 may include one or more CPUs, for example, a CPU 0 and a CPU 1 in FIG. 7.

In an embodiment, the communication apparatus 70 may include a plurality of processors, for example, a processor 701 and a processor 707 in FIG. 7. Each of these processors may be a single-core (single-CPU) processor, or may be a multi-core (multi-CPU) processor. The processor herein may be one or more devices, circuits, and/or processing cores configured to process data (for example, computer program instructions).

In an embodiment, the communication apparatus 70 may further include an output device 705 and/or an input device 706. The output device 705 is coupled to the processor 701, and may display information in a plurality of manners. For example, the output device 705 may be a liquid crystal display (LCD), a light-emitting diode (LED) display device, a cathode ray tube (CRT) display device, or a projector (projector). The input device 706 is coupled to the processor 701, and may receive input of a user in a plurality of manners. For example, the input device 706 may be a mouse, a keyboard, a touchscreen device, a sensing device, or the like.

The composition structure shown in FIG. 7 does not constitute a limitation on the communication apparatus. In addition to the parts shown in FIG. 7, the communication apparatus may include more or fewer parts than those shown in the figure, or some parts may be combined, or different part arrangements may be used.

The following describes the method with reference to the accompanying drawings. Network elements in the following embodiments may have the components shown in FIG. 7. Details are not described again.

“/” may indicate an “or” relationship between associated objects. For example, A/B may indicate A or B. “And/or” may be used to describe three relationships between associated objects. For example, A and/or B may indicate three cases: Only A exists, both A and B exist, and only B exists. A and B may be singular or plural. In addition, an expression similar to “at least one of A, B, and C” or “at least one of A, B, or C” can be used to represent any one of the following: only A exists; only B exists; only C exists; both A and B exist; both A and C exist; both B and C exist; and A, B, and C all exist. The foregoing uses three elements A, B, and C as an example to describe an optional item of the project. When there are more elements in the expression, a meaning of the expression may be obtained according to the foregoing rule.

For ease of description of the embodiments, the terms “first”, “second”, and the like may be used to distinguish between features with a same function or similar functions. The terms such as “first” and “second” do not limit a quantity or an execution order, and the terms such as “first” and “second” do not necessarily indicate a difference. Terms such as “example” or “for example” are used to represent giving an example, an illustration, or a description. Any embodiment described with “example” or “for example” should not be explained as being more preferred or having more advantages than another embodiment. The terms such as “example” or “for example” are used to present a related concept in a specific manner for ease of understanding.

An “embodiment” means that particular features, structures, or characteristics related to the embodiment are included in at least one embodiment. Therefore, embodiments do not necessarily refer to a same embodiment. Further, these specific features, structures, or characteristics may be combined in one or more embodiments in any suitable manner. In the embodiments, sequence numbers of processes do not mean a sequence of execution. The sequence of execution of the processes should be determined according to functions and internal logic of the processes, and should not constitute any limitation on an implementation process.

“When” and “if” mean that corresponding processing is performed in an objective situation, are not intended to limit time, do not necessarily require a determining action during implementation, and do not mean any other limitation.

“Simultaneously” may be being at a same time point, being in a period of time, or being in a same periodicity.

“A plurality of” may be two or more, unless otherwise specified. For example, a plurality of blockchain nodes may be two or more blockchain nodes.

In some scenarios, some optional features may be independently implemented without depending on other features, for example, a solution on which the optional features are currently based, to resolve a corresponding problem and achieve corresponding effects. Alternatively, in some scenarios, the optional features may be combined with other features based on a requirement. Correspondingly, the apparatus may also correspondingly implement these features or functions. Details are not described herein.

A same step, or steps, operations, or features that have a same function may be mutually referenced between different embodiments.

The following describes the service invocation method by using interaction between the node 6011, the node 6012, the node 6013, the RAN node 6021, and the terminal 6022 as an example. The node 6011, the node 6012, the node 6013, the RAN node 6021, or the terminal 6022 may perform some or all of the steps or operations. These steps or operations are merely examples. Other steps or variations of various steps (or operations) may be further performed. In addition, the steps or operations may be performed in a different sequence and not all the steps or operations may be performed.

In addition, in the following methods, an example in which the node 6011, the node 6012, the node 6013, the RAN node 6021, and the terminal 6022 are used as execution bodies of the interaction illustration is used to illustrate the methods. However, the execution bodies of the interaction illustration are not limited. For example, various nodes (for example, the node 6011, the node 6012, the node 6013, or the RAN node 6021) in the method provided in the following embodiments each may alternatively be a chip, a chip system, or a processor that supports the node in implementing the method, or may be a logical node, a logical module, or software that can implement all or some functions of the node. The terminal 6022 in the method provided below may alternatively be a chip, a chip system, or a processor that supports the terminal 6022 in implementing the method, or may be a logical node, a logical module, or software that can implement all or some functions of the terminal 6022.

FIG. 8 shows a service invocation method. The method may include the following steps or operations.

S801: A node 6011 obtains a first invocation request.

The first invocation request is used to invoke a first SC, the first SC is deployed on a first blockchain, and the first SC has a first network function of a core network. The first SC is installed on the node 6011, and the node 6011 is an execution node of the first SC.

In a possible embodiment, the first network function is configured to provide a subscription service, an authentication service, a registration service, a mobility management service, a policy management service, a data processing service, a charging service, a session management service, or at least one service that can be provided by a core network after 5G.

In a possible embodiment, the first network function includes at least one of the following: an access function, a mobility management function, a network repository function, unified data management, an authentication server function, a session management function, a user plane function, a policy control function, a network exposure function, a computing plane function, a data plane function, or a smart plane function. For example, the first network function is an AMF, an NRF, a UDM, an AUSF, an SMF, a UPF, a PCF, an NEF, or a function corresponding to a future network function.

The first invocation request includes information about the first SC. The information about the first SC may include an identifier of the first SC and/or an input parameter of the first network function.

In a possible embodiment, the information about the first SC further includes at least one of the following: an identifier of the first blockchain, information about an execution node of the first SC, information about a node on which the first SC is deployed, key information of the first SC, token access manner information of the first SC, version information of the first SC, or information about the first network function. For descriptions of the foregoing information, refer to the foregoing specific descriptions of the information about the SC.

The identifier of the first SC may enable the node 6011 to determine that an executed SC is the first SC. The input parameter of the first network function may enable the node 6011 to use the input parameter of the first network function as an input parameter of the first SC to execute the first SC. The identifier of the first blockchain may enable the node 6011 to determine that the first SC is deployed on the first blockchain, and then determine the first SC in the first blockchain based on the identifier of the first SC. With reference to the identifier of the first blockchain and the identifier of the first SC, a time for determining the first SC by the node 6011 may be shortened. The information about the execution node of the first SC may enable the node 6011 to determine specific execution nodes of the first SC, or determine whether the node 6011 is an execution node of the first SC.

The information about the node on which the first SC is deployed may enable the node 6011 to determine specific nodes on which the first SC is deployed, or determine whether the first SC is deployed on the node 6011. The key information of the first SC may enable the node 6011 to obtain the key information of the first SC, and verify, based on the key information of the first SC (for example, a public key or a public key certificate of the first SC), whether a node that initiates the first invocation request is valid. The token access manner information of the first SC may enable the node 6011 to determine a token access manner of the first SC, for example, identifiers of SCs that can be accessed by the first SC, and/or validity periods of SCs that can be accessed by the first SC, so as to subsequently access these SCs. The version information of the first SC may enable the node 6011 to determine a version number of the first SC, to perform comparison with a version of the first SC deployed on the node 6011, and determine whether the first invocation request can invoke the first SC deployed on the node 6011. The information about the first network function may enable the node 6011 to determine a network function of the first SC.

In different scenarios, manners in which the node 6011 obtains the first invocation request may be different. The following provides specific descriptions with reference to the following scenario 1 to scenario 3.

Scenario 1: The node 6011 obtains the first invocation request from a node that initiates service invocation.

The node that initiates service invocation includes a terminal 6022, a RAN node 6021, an AF network element, a network function network element, or an OAM network element. In other words, the terminal 6022, the RAN node 6021, the AF network element, the network function network element, or the OAM network element may initiate invocation of the first SC. The network function network element is a network element corresponding to a network function other than the first network function.

In a possible embodiment, when the node that initiates service invocation requests a first service from the network 601, the node determines the information about the first SC and the execution node (for example, the node 6011) of the first SC based on the first service, and sends the first invocation request to the node 6011. The node 6011 receives the first invocation request, for example, obtains the first invocation request. The first service may be any service provided by the network 601, for example, a terminal registration request service, a terminal service request service, a terminal configuration update service, an AF service request service, an AN release request service, an SMF service context transfer procedure service, or a network slice-specific authentication and authorization service.

In scenario 1, the node that initiates service invocation may store or pre-obtain a correspondence between the first service, the information about the first SC, and the execution node of the first SC (if the information about the first SC includes the information about the execution node of the first SC, the node that initiates service invocation stores a correspondence between the first service and the information about the first SC). For example, the information about the first SC includes the identifier of the first SC. The correspondence is shown in Table 1. If the node that initiates service invocation determines that the first service is a terminal registration request service, the node determines, based on Table 1, that the first SC is an AMF-SC 1, and the execution node of the first SC is a blockchain node 1.

Alternatively, if the node that initiates service invocation determines that the first service is a terminal service request service, the node determines, based on Table 1, that the first SC is an AMF-SC 2, and the execution node of the first SC is a blockchain node 2. Alternatively, if the node that initiates service invocation determines that the first service is a terminal configuration update service, the node determines, based on Table 1, that the first SC is an AMF-SC 3, and the execution node of the first SC is a blockchain node 3. Alternatively, if the node that initiates service invocation determines that the first service is an AF service request service, the node determines, based on Table 1, that the first SC is an NEF-SC, and the execution node of the first SC is a blockchain node 4. Alternatively, if the node that initiates service invocation determines that the first service is an AN release request service, the node determines, based on Table 1, that the first SC is an AMF-SC 4, and the execution node of the first SC is a blockchain node 5. Alternatively, if the node that initiates service invocation determines that the first service is an SMF service context transfer procedure service, the node determines, based on Table 1, that the first SC is an SMF-SC 1, and the execution node of the first SC is a blockchain node 6. Alternatively, if the node that initiates service invocation determines that the first service is a network slice-specific authentication and authorization service, the node determines, based on Table 1, that the first SC is an AMF-SC 5, and the execution node of the first SC is a blockchain node 7.

TABLE 1

| | Identifier | Execution node |
|---|---|---|
| | of the | of the |
| First service | first SC | first SC |
| Terminal registration request service | AMF-SC 1 | Blockchain node 1 |
| Terminal service request service | AMF-SC 2 | Blockchain node 2 |
| Terminal configuration update service | AMF-SC 3 | Blockchain node 3 |
| AF service request service | NEF-SC | Blockchain node 4 |
| AN release request service | AMF-SC 4 | Blockchain node 5 |
| SMF service context transfer | SMF-SC 1 | Blockchain node 6 |
| procedure service | | |
| Network slice-specific authentication | AMF-SC 5 | Blockchain node 7 |
| and authorization service | | |

Scenario 2: The node 6011 obtains the first invocation request from a scheduling node of the first SC.

The scheduling node of the first SC is configured to schedule a plurality of SCs, and the plurality of SCs include the first SC.

In a possible embodiment, a node that initiates service invocation determines the first service, determines the information about the first SC based on the first service, and sends the first invocation request to the scheduling node of the first SC. After receiving the first invocation request, the scheduling node of the first SC determines, based on the first invocation request, that the execution node of the first SC is the node 6011, and sends the first invocation request to the node 6011. The node 6011 receives the first invocation request, for example, obtains the first invocation request.

In a possible embodiment, the node that initiates service invocation stores a correspondence between the first service and the information about the first SC, so as to determine the first invocation request based on the first service and the correspondence. The scheduling node of the first SC stores a correspondence between the information about the first SC and the execution node of the first SC, so as to determine the execution node of the first SC based on the information about the first SC.

Scenario 3: The node 6011 obtains the first invocation request from an execution node of a third SC.

The execution node of the third SC is configured to execute the third SC. The third SC is used to invoke the first SC, for example, at least the third SC and the first SC need to be invoked to complete the first service, or an SC chain of the first service includes at least the third SC and the first SC. The third SC has a third network function. For example, the first service is an AF service request service, the third SC is an NEF-SC, the third network function is an NEF, the first SC is a UDM-SC, and the first network function is a UDM.

In a possible embodiment, a node that initiates service invocation determines the first service, determines information about the third SC and the execution node of the third SC based on the first service, and sends, to the execution node of the third SC, a third invocation request used to invoke the third SC. The third invocation request includes the information about the third SC, and content included in the information about the third SC is similar to content included in the information about the first SC. For details, refer to the foregoing descriptions corresponding to the information about the first SC. After receiving the third invocation request, the execution node of the third SC executes the third SC. Then, the execution node of the third SC determines that the first SC further needs to be invoked, and sends the first invocation request to the node 6011.

In scenario 3, the node that initiates service invocation stores a correspondence between the first service, the information about the third SC, and the execution node of the third SC (if the information about the third SC includes the information about the execution node of the third SC, the node that initiates service invocation stores a correspondence between the first service and the information about the third SC), so as to determine the information about the third SC and the execution node of the third SC based on the first service. After executing the third SC, the execution node of the third SC may obtain the information about the first SC. For example, an execution result of the third SC includes the information about the first SC, and the execution node of the third SC generates the first invocation request based on the information about the first SC. For another example, the node that initiates service invocation sends information about the first service, for example, an identifier of the first service, to the execution node of the third SC. The execution node of the third SC determines, based on the information about the first service, that an SC chain of the first service includes the third SC and the first SC, and sends the first invocation request to the execution node of the first SC.

In scenario 3, the execution node of the third SC may send the first invocation request to the execution node 6011, or send the first invocation request to the node 6011 through the scheduling node of the first SC.

S802: The node 6011 executes the first SC to obtain an execution result of the first SC.

In a possible embodiment, the node 6011 executes executable code corresponding to the first SC, to obtain the execution result of the first SC.

The execution result of the first SC includes indication information indicating whether the first SC is successfully executed. Optionally, the execution result of the first SC further includes at least one of the following: a cause of an execution error of the first SC or an output parameter of the first network function.

Optionally, the node 6011 sends the execution result of the first SC. For example, in scenario 1, the node 6011 sends the execution result of the first SC to the node that initiates service invocation. In scenario 2, the node 6011 sends the execution result of the first SC to the scheduling node of the first SC. After receiving the execution result of the first SC, the scheduling node of the first SC may send the execution result of the first SC to the node that initiates service invocation. In scenario 3, the node 6011 sends the execution result of the first SC to the execution node of the third SC. After receiving the execution result of the first SC, the execution node of the third SC may send the execution result of the third SC, or the execution result of the third SC and the execution result of the first SC to the node that initiates service invocation. The execution result of the third SC includes indication information indicating whether the third SC is successfully executed. Optionally, the execution result of the third SC further includes at least one of the following: a cause of an execution error of the third SC or an output parameter of the third network function.

Optionally, the node 6011 sends the execution result of the first SC to a blockchain node that maintains the first blockchain, so that the blockchain node verifies and records the execution result of the first SC.

For example, the first service is an AN release request service, and an AMF-SC needs to be invoked to complete the first service. The terminal 6022 may send the first invocation request to the node 6011 through the RAN node 6021. After receiving the first invocation request, the node 6011 executes the AMF-SC to implement a function of an AMF, for example, release a context of the terminal 6022, to obtain an execution result of the AMF-SC, and sends the execution result of the AMF-SC to the RAN node 6021. After receiving the execution result of the AMF-SC, the RAN node 6021 may send the execution result of the AMF-SC to the terminal 6022.

Based on the method shown in FIG. 8, the node 6011 may obtain the first invocation request, and execute the first SC based on the first invocation request, to invoke the first SC. Because the first SC has the first network function, executing the first SC by the node 6011 is equivalent to invoking the first network function, so that the first network function is invoked. In addition, because the first SC is deployed on the first blockchain, the first SC can be prevented from being tampered with, thereby improving communication security. In addition, the blockchain has a distributed architecture, so that the first SC can be flexibly deployed on the first blockchain. For example, the first SC is deployed on a plurality of blockchain nodes corresponding to the first blockchain. When a blockchain node fails, execution of the first SC is not affected, so that robustness of a communication system can be improved. In addition, the execution result of the first SC may be recorded on the first blockchain in a form of transaction, to facilitate tracing.

Optionally, in a possible embodiment of the method shown in FIG. 8, to complete the first service, the first SC needs to invoke a second SC. For example, for scenario 1 and scenario 2, at least the first SC and the second SC need to be invoked to complete the first service, or an SC chain of the first service includes at least the first SC and the second SC; and for scenario 3, at least the third SC, the first SC, and the second SC need to be invoked to complete the first service, or an SC chain of the first service includes at least the third SC, the first SC, and the second SC. In this case, the node 6011 further sends a second invocation request to invoke the second SC. For example, as shown in FIG. 9, the method shown in FIG. 8 further includes S803 and S804, or the method shown in FIG. 8 further includes S805 to S807.

S803: The node 6011 sends the second invocation request to an execution node of the second SC. Correspondingly, the execution node of the second SC receives the second invocation request from the node 6011.

The second invocation request is used to invoke the second SC. For example, the second invocation request includes information about the second SC. The second SC has a second network function of the core network. The second SC is deployed on the first blockchain or a second blockchain. If the second SC is deployed on the second blockchain, invocation performed by the first SC on the second SC is cross-chain invocation, and the execution node of the first SC and the execution node of the second SC are located on different blockchains. If the second SC is deployed on the first blockchain, content included in the information about the second SC is similar to content included in the information about the first SC. For details, refer to the foregoing descriptions corresponding to the information about the first SC. Details are not described herein again. If the second SC is deployed on the second blockchain, the information about the second SC includes an identifier of the second SC, an identifier of the second blockchain, and an input parameter of the second network function.

Optionally, the information about the second SC further includes at least one of the following: information about the execution node of the second SC, information about a node on which the second SC is deployed, key information of the second SC, token access manner information of the second SC, version information of the second SC, or information about the second network function. Optionally, the second invocation request further includes the identifier of the first blockchain and/or the information about the first SC. The identifier of the first blockchain may enable the execution node of the second SC to determine that an SC in the first blockchain invokes the second SC. The information about the first SC may enable the execution node of the second SC to determine corresponding information about the first SC that invokes the second SC.

In a possible embodiment, the execution result of the first SC includes the information about the second SC, and the node 6011 generates the second invocation request based on the information about the second SC, and sends the second invocation request to the execution node (for example, a node 6012) of the second SC. Alternatively, the node 6011 obtains the information about the first service, and determines, based on the information about the first service, that an SC chain of the first service includes the first SC and the second SC. The node 6011 stores the information about the second SC, generates the second invocation request based on the information about the second SC, and sends the second invocation request to the execution node of the second SC. Alternatively, logic for invoking the second SC is preset in the first SC, and in a process of executing the first SC, the node 6011 triggers invocation of the second SC. In this case, the node 6011 may continue to execute the first SC, or after obtaining an execution result of the second SC, continue to execute the first SC.

S804: The execution node of the second SC executes the second SC to obtain the execution result of the second SC.

A process in which the execution node of the second SC executes the second SC to obtain the execution result of the second SC may be similar to a process in which the execution node of the first SC executes the first SC to obtain the execution result of the first SC. Therefore, for details, refer to the corresponding descriptions in S802. Details are not described herein again.

Optionally, the execution node of the second SC sends the execution result of the second SC to the node 6011. Correspondingly, the node 6011 receives the execution result of the second SC from the execution node of the second SC. The node 6011 receives the execution result of the second SC, and may send the execution result of the second SC to the node that initiates service invocation, the scheduling node of the first SC, or the execution node of the third SC.

Optionally, if the second SC is deployed on the first blockchain, the execution node of the second SC sends the execution result of the second SC to a blockchain node that maintains the first blockchain, so that the blockchain node verifies and records the execution result of the second SC. If the second SC is deployed on the second blockchain, the execution node of the second SC sends the execution result of the second SC to a blockchain node that maintains the second blockchain, so that the blockchain node verifies and records the execution result of the second SC.

If the second SC further needs to invoke a fourth SC to complete the first service, the execution node of the second SC further sends an invocation request used to invoke the fourth SC until the first service is completed. A process in which the second SC invokes the fourth SC is similar to a process in which the first SC invokes the second SC. For details, refer to the foregoing corresponding descriptions.

For example, the first service is a terminal service request service, and the SC-chain of the first service includes an AMF-SC, an AUSF-SC, an SMF-SC, and a UPF-SC. The terminal 6022 may send the first invocation request to the node 6011 through the RAN node 6021, to invoke the AMF-SC. After receiving the first invocation request, the node 6011 executes the AMF-SC to implement a function of an AMF and obtain an execution result of the AMF-SC, and determines that the AUSF-SC further needs to be invoked. Therefore, the node 6011 sends the second invocation request to an execution node of the AUSF-SC, to invoke the AUSF-SC.

After receiving the second invocation request, the execution node of the AUSF-SC executes the AUSF-SC, to implement a function of an AUSF and obtain an execution result of the AUSF-SC, and determines that the SMF-SC further needs to be invoked. Therefore, the execution node of the AUSF-SC sends a fourth invocation request to an execution node of the SMF-SC, to invoke the SMF-SC. After receiving the fourth invocation request, the execution node of the SMF-SC executes the SMF-SC, to implement a function of an SMF and obtain an execution result of the SMF-SC, and determines that the UPF-SC further needs to be invoked.

Therefore, the execution node of the SMF-SC sends a fifth invocation request to an execution node of the UPF-SC, to invoke the UPF-SC. After receiving the fifth invocation request, the execution node of the UPF-SC executes the UPF-SC, to implement a function of a UPF and obtain an execution result of the UPF-SC, and sends the execution result of the UPF-SC to the execution node of the SMF-SC. After receiving the execution result of the UPF-SC, the execution node of the SMF-SC sends the execution result of the SMF-SC to the execution node of the AUSF-SC. After receiving the execution result of the SMF-SC, the execution node of the AUSF-SC sends the execution result of the AUSF-SC to the node 6011. After receiving the execution result of the AUSF-SC, the node 6011 sends the execution result of the AMF-SC to the terminal 6022 via the RAN node 6021.

In S803 and S804, the node 6011 sends the second invocation request to the execution node of the second SC. The second SC may have a corresponding scheduling node, and the node 6011 may send the second invocation request to the scheduling node of the second SC, so that the scheduling node of the second SC sends the second invocation request to the execution node of the second SC. Therefore, S803 and S804 may be replaced with S805 to S807.

S805: The node 6011 sends the second invocation request to the scheduling node of the second SC. Correspondingly, the scheduling node of the second SC receives the second invocation request from the node 6011.

The scheduling node of the second SC is configured to schedule a plurality of SCs, and the plurality of SCs include the second SC. For descriptions of the second SC and the second invocation request, refer to corresponding descriptions in S803.

In a possible embodiment, the execution result of the first SC includes the information about the second SC and information about the scheduling node of the second SC, the second invocation request is generated based on the information about the second SC, and the second invocation request is sent to the scheduling node of the second SC. Alternatively, the node 6011 obtains the information about the first service, and determines, based on the information about the first service, that an SC chain of the first service includes the first SC and the second SC. The node 6011 stores a correspondence between the second SC and the scheduling node of the second SC, and the information about the second SC, generates the second invocation request based on the information about the second SC, determines the scheduling node of the second SC based on the correspondence, and sends the second invocation request to the scheduling node of the second SC.

S806: The scheduling node of the second SC sends the second invocation request to the execution node of the second SC. Correspondingly, the execution node of the second SC receives the second invocation request from the scheduling node of the second SC.

After receiving the second invocation request, the scheduling node of the second SC may query the execution node of the second SC based on the information about the second SC included in the second invocation request, and send the second invocation request to the execution node of the second SC.

After receiving the second invocation request, the scheduling node of the second SC may further process the second invocation request, for example, perform an operation such as re-encapsulation, adding new information, or deleting information, to obtain a sixth invocation request used to invoke the second SC, and send the sixth invocation request to the execution node of the second SC, to invoke the second SC.

S807: The execution node of the second SC executes the second SC to obtain the execution result of the second SC.

A process in which the execution node of the second SC executes the second SC to obtain the execution result of the second SC may be similar to a process in which the execution node of the first SC executes the first SC to obtain the execution result of the first SC. Therefore, for details, refer to the corresponding descriptions in S802. Details are not described herein again.

Optionally, the execution node of the second SC sends the execution result of the second SC to the node 6011 through the scheduling node of the second SC. Correspondingly, the node 6011 receives, through the scheduling node of the second SC, the execution result of the second SC from the execution node of the second SC. The node 6011 receives the execution result of the second SC, and may send the execution result of the second SC to the node that initiates service invocation, the scheduling node of the first SC, or the execution node of the third SC.

Optionally, if the second SC is deployed on the first blockchain, the execution node of the second SC sends the execution result of the second SC to a blockchain node that maintains the first blockchain, so that the blockchain node verifies and records the execution result of the second SC. If the second SC is deployed on the second blockchain, the execution node of the second SC sends the execution result of the second SC to a blockchain node that maintains the second blockchain, so that the blockchain node verifies and records the execution result of the second SC.

If the second SC further needs to invoke a fourth SC to complete the first service, the execution node of the second SC further sends, to a scheduling node of the fourth SC or an execution node of the fourth SC, an invocation request used to invoke the fourth SC until the first service is completed. A process in which the second SC invokes the fourth SC is similar to a process in which the first SC invokes the second SC. For details, refer to the foregoing corresponding descriptions.

Actions of the node 6011, the terminal 6022, the RAN node 6021, the AF network element, the network function network element, the OAM network element, the execution node of the first SC, the scheduling node of the first SC, the execution node of the second SC, or the scheduling node of the second SC in S801 to S807 may be performed by the processor 701 in the communication apparatus 70 shown in FIG. 7 by invoking the application program code stored in the memory 703. This is not limited.

In the method shown in FIG. 8 or FIG. 9, the terminal 6022, the RAN node 6021, the AF network element, the network function network element, or the OAM network element may determine, based on the first service, an SC to be invoked. In other words, the terminal 6022, the RAN node 6021, the AF network element, the network function network element, or the OAM network element has a capability of invoking an SC. In addition, when the first service corresponds to an SC chain, an execution node of an SC in the SC chain may trigger invocation of a next SC, so as to form the SC chain, to complete invocation of the first service. To complete the foregoing operations, corresponding operation procedures need to be preset in the terminal 6022, the RAN node 6021, the AF network element, the network function network element, the OAM network element, and the execution node of the SC in the SC chain. Therefore, the method shown in FIG. 8 or FIG. 9 is applicable to a standardized service invocation procedure, a fixed service invocation procedure, or a service invocation procedure triggered by a specific node, and execution efficiency is relatively high.

Universality of the method in which corresponding operation procedures need to be preset in the terminal 6022, the RAN node 6021, the AF network element, the network function network element, the OAM network element, and the execution node of the SC in the SC chain may be low. Therefore, to consider an apparatus that does not have a capability of invoking an SC or a node that does not have a capability of triggering invocation of an SC, the node 6013 may be deployed in the network 601, to parse an invocation request for a service, so as to obtain an SC chain of the service. Optionally, the node 6013 may further manage invocation of an SC in the SC chain. The following provides detailed descriptions.

FIG. 10 shows another service invocation method. The method may include the following steps or operations.

S1001: A node 6013 obtains an invocation request for a first service.

The invocation request for the first service is used to invoke the first service. For descriptions of the first service, refer to corresponding descriptions in S801. The invocation request for the first service includes information about the first service, for example, an identifier of the first service and/or a parameter of the first service.

In a possible embodiment, a node that initiates service invocation, for example, a terminal 6022, a RAN node 6021, an AF network element, a network function network element, or an OAM network element, sends the invocation request for the first service to the node 6013. Correspondingly, the node 6013 receives the invocation request for the first service from the terminal 6022, the RAN node 6021, the AF network element, the network function network element, or the OAM network element. The node 6013 receives the invocation request for the first service, for example, obtains the invocation request for the first service.

S1002: The node 6013 determines invocation information of at least one SC corresponding to the invocation request for the first service.

The at least one SC is an SC included in an SC chain of the first service. Any one of the at least one SC is deployed on a blockchain, and has a network function of a core network. The network function of the core network is configured to provide at least one of the following services: a subscription service, an authentication service, a registration service, a mobility management service, a policy management service, a data processing service, a charging service, a session management service, or at least one service that can be provided by a core network after 5G. The network function of the core network may include at least one of the following: an access function, a mobility management function, a network repository function, unified data management, an authentication server function, a session management function, a user plane function, a policy control function, a network exposure function, a computing plane function, a data plane function, or a smart plane function. For example, the network function of the core network includes at least one of the following: an AMF, an NRF, a UDM, an AUSF, an SMF, a UPF, a PCF, an NEF, or a function corresponding to a further network function.

The invocation information of the at least one SC indicates the at least one SC and an invocation sequence of the at least one SC. For example, the invocation information includes information about each SC in the at least one SC, and a location of the information about the SC in the invocation information may indicate an invocation ranking of the SC. Content included in information about any SC is similar to content included in the information about the first SC in S801. For details, refer to corresponding descriptions in S801. Optionally, the invocation information of the at least one SC further includes an identifier for identifying an execution sequence of the SC.

For example, if the at least one SC includes a first SC and a second SC, the invocation information of the at least one SC may be shown in Table 2. The invocation information shown in Table 2 indicates that the SC chain of the first service includes the first SC and the second SC. When the first service is invoked, the network 601 first invokes the first SC, and the first SC invokes the second SC.

TABLE 2

| Identifier for identifying | |
|---|---|
| an SC execution sequence | SC information |
| 1 | Information about the first SC |
| 2 | Information about the second SC |

Table 2 is merely an example of the invocation information of the at least one SC. The invocation information of the at least one SC may include more or fewer rows than those in Table 2, or include more or fewer columns than those in Table 2. In addition, the invocation information of the at least one SC may be alternatively represented in a form other than a list. This is not limited.

In a possible embodiment, the node 6013 obtains the invocation information of the at least one SC based on the information about the first service.

For example, the node 6013 stores a correspondence between the information about the first service and the invocation information of the at least one SC. After receiving the invocation request for the first service, the node 6013 may obtain the invocation information of the at least one SC based on the information about the first service and the correspondence. In this way, corresponding invocation information may be determined for a standardized service. The standardized service may be a service that has been determined in a service invocation procedure.

For example, a neural network model or executable code is preset in the node 6013. The neural network model or the executable code may determine corresponding invocation information for a service based on information about the service. In this way, corresponding invocation information may be determined for a standardized service and/or a non-standardized service. The non-standardized service may be a service that is not determined in a service invocation procedure, for example, a new service or a service that has different service invocation procedures for different service providers.

Based on the method shown in FIG. 10, the node 6013 may obtain the invocation request for the first service, and determine the invocation information of the at least one SC corresponding to the invocation request for the first service, to subsequently invoke the SC based on the invocation information, thereby invoking the first service. In the method shown in FIG. 10, the node 6013 has a capability of parsing the invocation request for the first service, and may determine the SC chain of the first service. Therefore, the node that initiates service invocation may not have a capability of invoking an SC.

This simplifies an operation of the node that initiates service invocation, improves compatibility of the method shown in FIG. 10, and reduces complexity of the node that initiates service invocation, and a requirement on performance of the node that initiates service invocation is relatively low. In addition, because any one of the at least one SC is deployed on the blockchain and has the network function of the core network, the SC can be prevented from being tampered with, thereby improving communication security. In addition, the blockchain has a distributed architecture, so that the SC can be flexibly deployed on the blockchain. For example, the SC is deployed on a plurality of blockchain nodes corresponding to the blockchain. When a blockchain node fails, execution of the SC is not affected, so that robustness of a communication system can be improved.

Optionally, in a possible embodiment of the method shown in FIG. 10, the node 6013 may manage invocation of an SC in the SC chain. For example, the node 6013 initiates invocation to an execution node of a 1^{st} SC in the at least one SC, and sends the invocation information of the at least one SC, so that the execution node invokes a next SC. For this process, refer to the following S1003 to S1008. For another example, the node 6013 sequentially invokes the at least one SC based on the invocation information of the at least one SC. For this process, refer to the following S1009 to S1014. The following provides specific descriptions by using an example in which the at least one SC includes a first SC and a second SC, and the first SC is used to invoke the second SC. The first SC has a first network function of the core network, and the second SC has a second network function of the core network. The first SC and the second SC are deployed on a same blockchain, or are separately deployed on different blockchains.

As shown in FIG. 11, the method shown in FIG. 10 further includes S1003 to S1008 or S1009 to S1014.

S1003: The node 6013 sends a first invocation request and the invocation information of the at least one SC to an execution node of the first SC. Correspondingly, the execution node of the first SC receives the first invocation request and the invocation information of the at least one SC from the node 6013.

The first invocation request is used to invoke the first SC, the first SC is deployed on a first blockchain, and the first SC has the first network function of the core network. The first SC is installed on the execution node of the first SC, and the execution node is configured to execute the first SC. Optionally, the first network function is configured to provide a subscription service, an authentication service, a registration service, a mobility management service, a policy management service, a data processing service, a charging service, a session management service, or at least one service that can be provided by a core network after 5G. The first network function may be an access function, a mobility management function, a network repository function, unified data management, an authentication server function, a session management function, a user plane function, a policy control function, a network exposure function, a computing plane function, a data plane function, or a smart plane function. For example, the first network function is an AMF, an NRF, a UDM, an AUSF, an SMF, a UPF, a PCF, an NEF, or a function corresponding to a future network function. The first invocation request includes information about the first SC. For details, refer to corresponding descriptions in S801.

The node 6013 may directly send the first invocation request to the execution node of the first SC, or send the first invocation request to the execution node of the first SC through a scheduling node of the first SC. For example, the node 6013 determines the execution node of the first SC based on the information about the first SC, and sends the first invocation request to the execution node of the first SC. For another example, the node 6013 determines the scheduling node of the first SC based on the information about the first SC, and sends the first invocation request to the scheduling node of the first SC. After receiving the first invocation request, the scheduling node of the first SC sends the first invocation request to the execution node of the first SC.

S1004: The execution node of the first SC executes the first SC to obtain an execution result of the first SC.

A process of S1004 may be similar to a process of S802. For details, refer to corresponding descriptions in S802. Details are not described again.

S1005: The execution node of the first SC sends a second invocation request to an execution node of the second SC. Correspondingly, the execution node of the second SC receives the second invocation request from the execution node of the first SC.

The execution node of the first SC may determine, based on the invocation information of the at least one SC, to invoke the second SC, and sends the second invocation request to the execution node of the second SC. The execution node of the first SC may directly send the second invocation request to the execution node of the second SC, or send the second invocation request to the execution node of the second SC through a scheduling node of the second SC.

S1006: The execution node of the second SC executes the second SC to obtain an execution result of the second SC.

A process of S1005 and S1006 may be similar to a process of S803 and S804. For details, refer to corresponding descriptions in S803 and S804. Details are not described again.

If the at least one SC further includes another SC, the execution node of the second SC continues to send an invocation request and invocation information of an SC other than the first SC and the second SC in the at least one SC, until invocation of the at least one SC is completed. For example, if the at least one SC further includes a fourth SC and a fifth SC, the second SC is used to invoke the fourth SC, and the fourth SC is used to invoke the fifth SC, the execution node of the second SC sends a fourth invocation request and invocation information of the fifth SC to an execution node of the fourth SC. After receiving the fourth invocation request and the invocation information of the fifth SC, the execution node of the fourth SC executes the fourth SC based on the fourth invocation request, and initiates invocation of the fifth SC based on the invocation information of the fifth SC.

S1007: The execution node of the second SC sends the execution result of the second SC to the execution node of the first SC. Correspondingly, the execution node of the first SC receives the execution result of the second SC from the execution node of the second SC.

S1008: The execution node of the first SC sends the execution result of the first SC to the node 6013. Correspondingly, the node 6013 receives the execution result of the first SC from the execution node of the first SC.

After invocation of the at least one SC is completed, for example, after the node 6013 receives the execution result of the first SC, an invocation result for the first service may be sent to the node that initiates service invocation. The invocation result for the first service includes indication information indicating whether the first service is successfully invoked. Optionally, the invocation result for the first service further includes at least one of the following: a cause of an invocation error of the first service or a parameter to be returned when the first service is invoked.

In S1003 to S1008, after parsing the invocation request for the first service to obtain the invocation information of the at least one SC, the node 6013 may deliver the invocation information of the at least one SC to an execution node of an SC, so that the execution node of the SC sequentially invokes the SC in the invocation sequence indicated by the invocation information. The node 6013 may alternatively not deliver the invocation information of the at least one SC, but autonomously manage invocation of the SC. Details may be described in S1009 to S1014.

S1009: The node 6013 sends a first invocation request to an execution node of the first SC. Correspondingly, the execution node of the first SC receives the first invocation request from the node 6013.

S1010: The execution node of the first SC executes the first SC to obtain an execution result of the first SC.

A process of S1009 and S1010 may be similar to a process of S1003 and S1004. For details, refer to corresponding descriptions in S1003 and S1004. Details are not described again.

S1011: The execution node of the first SC sends the execution result of the first SC to the node 6013. Correspondingly, the node 6013 receives the execution result of the first SC from the execution node of the first SC.

S1012: The node 6013 sends a second invocation request to an execution node of the second SC. Correspondingly, the execution node of the second SC receives the second invocation request from the node 6013.

S1013: The execution node of the second SC executes the second SC to obtain an execution result of the second SC.

A process of S1012 and S1013 may be similar to a process of S1003 and S1004. For details, refer to corresponding descriptions in S1003 and S1004. Details are not described again.

S1014: The execution node of the second SC sends the execution result of the second SC to the node 6013. Correspondingly, the node 6013 receives the execution result of the second SC from the execution node of the second SC.

If the at least one SC further includes another SC, the node 6013 continues to send an invocation request until invocation of the at least one SC is completed. For example, if the at least one SC further includes a fourth SC, and the second SC is used to invoke the fourth SC, the node 6013 sends a fourth invocation request to an execution node of the fourth SC, to invoke the fourth SC.

After invocation of the at least one SC is completed, for example, after the node 6013 receives the execution result of the second SC, an invocation result for the first service may be sent to the node that initiates service invocation.

Actions of the node 6013, the terminal 6022, the RAN node 6021, the AF network element, the network function network element, the OAM network element, the execution node of the first SC, the scheduling node of the first SC, the execution node of the second SC, or the scheduling node of the second SC in S1001 to S1014 may be performed by the processor 701 in the communication apparatus 70 shown in FIG. 7 by invoking the application program code stored in the memory 703. This is not limited.

In the method shown in FIG. 10 or FIG. 11, a coordinator node, for example, the node 6013, is deployed in the network 601, and may be configured to parse a service invocation request to obtain an SC chain of a service. Subsequently, the coordinator node may further manage invocation of an SC in the SC chain. For a scenario in which service invocation is complex or a scenario in which a computing capability of a coordinator node is relatively weak, it may be considered that a plurality of coordinator nodes are deployed in the network 601, and service invocation requests processed and/or SCs invoked by different coordinator nodes may be divided according to a specific policy.

In a possible embodiment, the plurality of coordinator nodes respectively correspond to different nodes that initiate service invocation. For example, the plurality of coordinator nodes respectively correspond to different external function interfaces, and receive service invocation requests sent by different nodes that initiate service invocation.

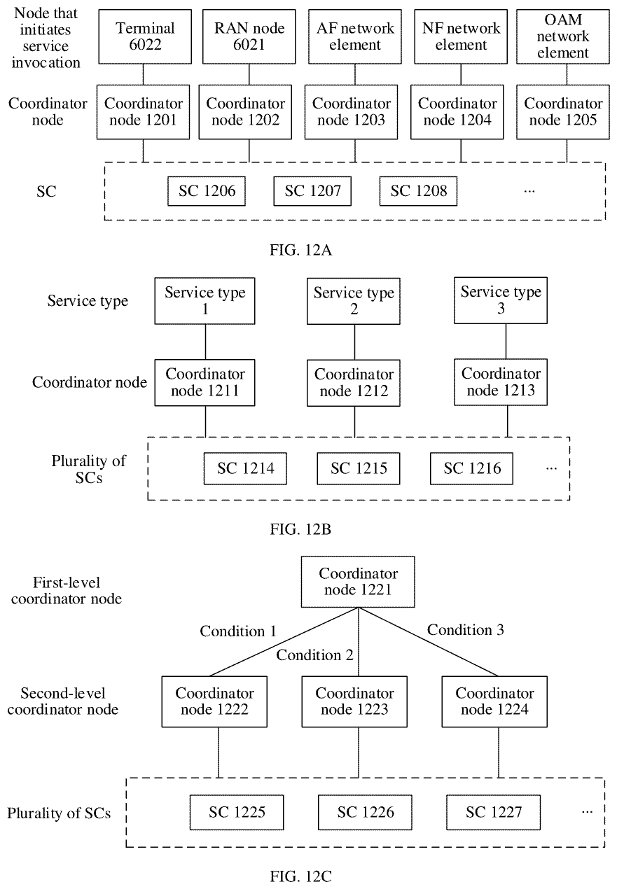

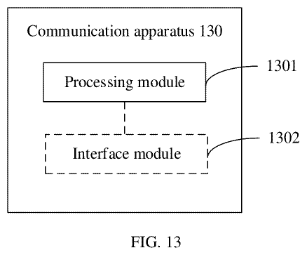

For example, five coordinator nodes are deployed in the network 601, which are respectively a coordinator node 1201 to a coordinator node 1205, and a plurality of SCs such an SC 1206, an SC 1207, and an SC 1208 are deployed in the network 601. A correspondence between a node (such as a terminal 6022, a RAN node 6021, an AF network element, a network function network element, or an OAM network element) that initiates service invocation and a coordinator node may be shown in FIG. 12A.

A service invocation request sent by the terminal 6022 is sent to the coordinator node 1201. After parsing the service invocation request, the coordinator node 1201 invokes, by using the method shown in FIG. 11, an SC corresponding to the service invocation request, for example, an SC in FIG. 12A.

A service invocation request sent by the RAN node 6021 is sent to the coordinator node 1202. After parsing the service invocation request, the coordinator node 1202 invokes, by using the method shown in FIG. 11, an SC corresponding to the service invocation request, for example, an SC in FIG. 12A.

A service invocation request sent by the AF network element is sent to the coordinator node 1203. After parsing the service invocation request, the coordinator node 1203 invokes, by using the method shown in FIG. 11, an SC corresponding to the service invocation request, for example, an SC in FIG. 12A.

A service invocation request sent by the network function network element is sent to the coordinator node 1204. After parsing the service invocation request, the coordinator node 1204 invokes, by using the method shown in FIG. 11, an SC corresponding to the service invocation request, for example, an SC in FIG. 12A.

A service invocation request sent by the OAM network element is sent to the coordinator node 1205. After parsing the service invocation request, the coordinator node 1205 invokes, by using the method shown in FIG. 11, an SC corresponding to the service invocation request, for example, an SC in FIG. 12A.

In FIG. 12A, each node that initiates service invocation corresponds to a different coordinator node. Some nodes that initiate service invocation may share one coordinator node. For example, the node 1202 is not deployed in the network 601, and the terminal 6022 and the RAN node 6021 share the coordinator node 1201.

In a possible embodiment, the plurality of coordinator nodes respectively may correspond to invocation requests for different types of services. For example, the plurality of coordinator nodes respectively correspond to different external function interfaces, and receive invocation requests for different types of services.

For example, three coordinator nodes are deployed in the network 601, which are respectively a coordinator node 1211 to a coordinator node 1213, and a plurality of SCs such an SC 1214, an SC 1215, and an SC 1216 are deployed in the network 601. A correspondence between a service type and a coordinator node may be shown in FIG. 12B. An invocation request for a service of a service type 1 is sent to the coordinator node 1211. After parsing the invocation request for the service, the coordinator node 1211 invokes, by using the method shown in FIG. 11, an SC corresponding to the invocation request for the service, for example, an SC in FIG. 12B. An invocation request for a service of a service type 2 is sent to the coordinator node 1212. After parsing the invocation request for the service, the coordinator node 1212 invokes, by using the method shown in FIG. 11, an SC corresponding to the invocation request for the service, for example, an SC in FIG. 12B. An invocation request for a service of a service type 3 is sent to the coordinator node 1213. After parsing the invocation request for the service, the coordinator node 1213 invokes, by using the method shown in FIG. 11, an SC corresponding to the invocation request for the service, for example, an SC in FIG. 12B. Some service types may share one coordinator node. For example, the node 1213 is not deployed in the network 601, and the service type 2 and the service type 3 share the coordinator node 1212.

In a possible embodiment, there is a hierarchical relationship between the plurality of coordinator nodes. For example, after obtaining an SC chain of a service by parsing a service invocation request, a coordinator node distributes the SC chain to a coordinator node at a next layer according to a specific policy, so that the coordinator node at the next layer invokes an SC in the SC chain.

For example, four coordinator nodes are deployed in the network 601, which are respectively a coordinator node 1221 to a coordinator node 1224, and a plurality of SCs such as an SC 1225, an SC 1226, and an SC 1227 are deployed in the network 601. After obtaining an SC chain of a service by parsing a service invocation request, the coordinator node 1221 distributes an SC chain that satisfies a condition 1 to the coordinator node 1222, so that the coordinator node 1222 invokes an SC in the SC chain, for example, an SC in FIG. 12C, by using the method shown in FIG. 11; distributes an SC chain that satisfies a condition 2 to the coordinator node 1223, so that the coordinator node 1223 invokes an SC in the SC chain, for example, an SC in FIG. 12C, by using the method shown in FIG. 11; and distributes an SC chain that satisfies a condition 3 to the coordinator node 1224, so that the coordinator node 1224 invokes an SC in the SC chain, for example, an SC in FIG. 12C, by using the method shown in FIG. 11. The foregoing condition 1, condition 2, and condition 3 may be set according to a requirement, for example, a condition is set based on a network function. For example, the condition 1 is that the SC in the SC chain includes an AMF-SC, the condition 2 is that the SC in the SC chain includes an SMF-SC and a UPF-SC, and the condition 3 is that the SC in the SC chain includes an AUSF-SC.

A manner of hierarchically dividing the plurality of coordinator nodes may also be applied to FIG. 12A or FIG. 12B. In an example in which the manner of hierarchically dividing the plurality of coordinator nodes is applied to FIG. 12A, a service invocation request sent by the terminal 6022 is sent to the coordinator node 1201, and after parsing the service invocation request to obtain an SC chain of a service, the coordinator node 1201 distributes the SC chain to a coordinator node at a next layer according to a specific policy, so that the coordinator node at the next layer invokes an SC in the SC chain. The coordinator node 1202 to the coordinator node 1205 may also perform processing similar to that of the coordinator node 1201, and details are not described again.

In the foregoing example, SCs that can be invoked by different coordinator nodes may be the same or different. The coordinator node 1201 and the coordinator node 1204 are used as an example. Both the coordinator node 1201 and the coordinator node 1204 can invoke the SC 1206 to the SC 1208, or the coordinator node 1201 can invoke the SC 1206 and the SC 1207, and the coordinator node 1204 can invoke the SC 1206 and the SC 1208.

The embodiments mentioned above may be combined when the solutions do not conflict. This is not limited.

The foregoing describes the embodiments from a perspective of interaction between nodes. Correspondingly, the embodiments may further provide a communication apparatus. The communication apparatus may be the node 6011 in the foregoing method embodiments, or an apparatus including the node 6011, or a component that can be used in the node 6011. Alternatively, the communication apparatus may be the node 6013 in the foregoing method embodiments, or an apparatus including the node 6013, or a component that can be used in the node 6013. Alternatively, the communication apparatus may be the node that initiates service invocation in the foregoing method embodiments, or an apparatus including the node that initiates service invocation, or a component that can be used in the node that initiates service invocation.

To implement the foregoing functions, the node 6011, the node 6013, the node that initiates service invocation, or the like includes corresponding hardware structures and/or software modules for performing the functions. A person skilled in the art should be easily aware that the example units and algorithm operations described in the embodiments may be implemented in a form of hardware or a combination of hardware and computer software. Whether a function is performed by hardware or hardware driven by computer software depends on particular applications and design constraints. A person skilled in the art may use different methods to implement the described functions, but it should not be considered that the implementation goes beyond the scope of the embodiments.

The node 6011, the node 6013, or the node that initiates service invocation may be divided into functional modules based on the foregoing method examples. For example, each functional module may be obtained through division based on each corresponding function, or two or more functions may be integrated into one processing module. The integrated module may be implemented in a form of hardware, or may be implemented in a form of a software functional module. Division into the modules may be an example, and may be merely logical function division. During actual implementation, there may be another division manner.

For example, when each functional module is obtained through division in an integrated manner, FIG. 13 is a diagram of a structure of a communication apparatus 130. The communication apparatus 130 includes a processing module 1301. Optionally, the communication apparatus 130 further includes an interface module 1302. The processing module 1301 may also be referred to as a processing unit, and is configured to perform an operation other than a sending operation and a receiving operation. For example, the processing module may be a processing circuit or a processor. The interface module 1302 may also be referred to as an interface unit, and is configured to perform a sending operation and a receiving operation. For example, the interface module may be an interface circuit, a transceiver machine, a transceiver, or a communication interface.

In some embodiments, the communication apparatus 130 may further include a storage module (not shown in FIG. 13), configured to store program instructions and data.

For example, the communication apparatus 130 is configured to implement a function of the node 6013. For example, the communication apparatus 130 is the node 6013 in the embodiment shown in FIG. 10 or the embodiment shown in FIG. 11.

The processing module 1301 is configured to obtain an invocation request for a first service. For example, the processing module 1301 may be configured to perform S1001.

The processing module 1301 is further configured to determine invocation information of at least one smart contract corresponding to the invocation request for the first service. Any one of the at least one smart contract is deployed on a blockchain and has a network function of a core network. For example, the processing module 1301 may be configured to perform S1002.

In a possible embodiment, the network function of the core network is configured to provide at least one of the following services: a subscription service, an authentication service, a registration service, a mobility management service, a policy management service, a data processing service, a charging service, a session management service, or at least one service that can be provided by a core network after 5G.

In a possible embodiment, the at least one smart contract includes a first smart contract, and the interface module 1302 is configured to send a first invocation request, where the first invocation request is used to invoke the first smart contract.

In a possible embodiment, the interface module 1302 may be configured to send the first invocation request to a scheduling node of the first smart contract; or the interface module 1302 may be configured to send the first invocation request to an execution node of the first smart contract.

In a possible embodiment, the interface module 1302 is further configured to receive an execution result of the first smart contract.

In a possible embodiment, the interface module 1302 is further configured to send the invocation information of the at least one smart contract.

In a possible embodiment, the at least one smart contract further includes a second smart contract, the first smart contract is used to invoke the second smart contract, and the interface module 1302 is further configured to send a second invocation request, where the second invocation request is used to invoke the second smart contract.

In a possible embodiment, the interface module 1302 may be configured to send the second invocation request to a scheduling node of the second smart contract; or the interface module 1302 may be configured to send the second invocation request to an execution node of the second smart contract.

In a possible embodiment, the interface module 1302 may be configured to receive an execution result of the second smart contract.

In a possible embodiment, the first smart contract has a first network function of the core network, and the second smart contract has a second network function of the core network.

In a possible embodiment, the first invocation request includes an identifier of the first smart contract and an input parameter of the first network function.

In a possible embodiment, the first invocation request further includes at least one of the following: an identifier of the first blockchain, information about an execution node of the first smart contract, information about a node on which the first smart contract is deployed, key information of the first smart contract, token access manner information of the first smart contract, version information of the first smart contract, or information about the first network function.

In a possible embodiment, the first network function is an access function, a mobility management function, a network repository function, unified data management, an authentication server function, a session management function, a user plane function, a policy control function, a network exposure function, a computing plane function, a data plane function, or a smart plane function.

In a possible embodiment, the processing module 1301 may be configured to receive, through the interface module 1302, the invocation request for the first service from a terminal, a radio access network node, an application function network element, a network function network element, or an operation, administration and maintenance network element.

In a possible embodiment, the invocation information of the at least one smart contract indicates the at least one smart contract and an invocation sequence of the at least one smart contract.

In a possible embodiment, the interface module 1302 is configured to send an invocation result for the first service.

When the communication apparatus 130 is configured to implement the function of the node 6013, for another function that can be implemented by the communication apparatus 130, refer to the related descriptions of the embodiment shown in FIG. 10 or the embodiment shown in FIG. 11. Details are not described again.

Alternatively, for example, the communication apparatus 130 is configured to implement a function of the node 6011. For example, the communication apparatus 130 is the node 6011 in the embodiment shown in FIG. 8 or the embodiment shown in FIG. 9.

The processing module 1301 is configured to obtain a first invocation request. The first invocation request is used to invoke a first smart contract, the first smart contract is deployed on a first blockchain, and the first smart contract has a first network function of a core network. For example, the processing module 1301 may be configured to perform S801.

The processing module 1301 is further configured to execute the first smart contract to obtain an execution result of the first smart contract. For example, the processing module 1301 may be configured to perform S802.

In a possible embodiment, the first network function is configured to provide a subscription service, an authentication service, a registration service, a mobility management service, a policy management service, a data processing service, a charging service, a session management service, or at least one service that can be provided by a core network after 5G.

In a possible embodiment, the first smart contract is used to invoke a second smart contract, and the interface module 1302 is configured to send a second invocation request, where the second invocation request is used to invoke the second smart contract.

In a possible embodiment, the interface module 1302 may be configured to send the second invocation request to a scheduling node of the second smart contract; or the interface module 1302 may be configured to send the second invocation request to an execution node of the second smart contract.

In a possible embodiment, the interface module 1302 is configured to receive an execution result of the second smart contract.

In a possible embodiment, the second smart contract has a second network function of the core network.

In a possible embodiment, the first invocation request includes an identifier of the first smart contract and an input parameter of the first network function.

In a possible embodiment, the first invocation request further includes at least one of the following: an identifier of the first blockchain, information about an execution node of the first smart contract, information about a node on which the first smart contract is deployed, key information of the first smart contract, token access manner information of the first smart contract, version information of the first smart contract, or information about the first network function.

In a possible embodiment, the processing module 1301 may be configured to receive, through the interface module 1302, the first invocation request from a scheduling node of the first smart contract, a terminal, a radio access network node, an application function network element, a network function network element, an operation, administration and maintenance network element, or an execution node of a third smart contract, where the third smart contract is used to invoke the first smart contract.

In a possible embodiment, the first network function is an access function, a mobility management function, a network repository function, unified data management, an authentication server function, a session management function, a user plane function, a policy control function, a network exposure function, a computing plane function, a data plane function, or a smart plane function.

When the communication apparatus 130 is configured to implement the function of the node 6011, for another function that can be implemented by the communication apparatus 130, refer to the related descriptions of the embodiment shown in FIG. 8 or the embodiment shown in FIG. 9. Details are not described again.

Alternatively, for example, the communication apparatus 130 is configured to implement a function of the node that initiates service invocation. For example, the communication apparatus 130 is the node that initiates service invocation in the embodiment shown in FIG. 8 or the embodiment shown in FIG. 9.

The processing module 1301 is configured to determine a first invocation request. The first invocation request is used to invoke a first smart contract, the first smart contract is deployed on a first blockchain, and the first smart contract has a first network function of a core network.

The interface module 1302 is configured to send the first invocation request.

In a possible embodiment, the first network function is configured to provide a subscription service, an authentication service, a registration service, a mobility management service, a policy management service, a data processing service, a charging service, a session management service, or at least one service that can be provided by a core network after 5G.

In a possible embodiment, the first invocation request includes an identifier of the first smart contract and an input parameter of the first network function.

In a possible embodiment, the first invocation request further includes at least one of the following: an identifier of the first blockchain, information about an execution node of the first smart contract, information about a node on which the first smart contract is deployed, key information of the first smart contract, token access manner information of the first smart contract, version information of the first smart contract, or information about the first network function.

In a possible embodiment, the first network function is an access function, a mobility management function, a network repository function, unified data management, an authentication server function, a session management function, a user plane function, a policy control function, a network exposure function, a computing plane function, a data plane function, or a smart plane function.

In a possible embodiment, the interface module 1302 is further configured to receive an execution result of the first smart contract.

When the communication apparatus 130 is configured to implement the function of the node that initiates service invocation, for another function that can be implemented by the communication apparatus 130, refer to the related descriptions of the embodiment shown in FIG. 8 or the embodiment shown in FIG. 9. Details are not described again.

In a simple embodiment, a person skilled in the art may figure out that the communication apparatus 130 may be in the form shown in FIG. 7. For example, the processor 701 in FIG. 7 may invoke the computer-executable instructions stored in the memory 703, to enable the communication apparatus 130 to perform the method in the foregoing method embodiments.

For example, functions/implementation processes of the processing module 1301 and the interface module 1302 in FIG. 13 may be implemented by invoking, by the processor 701 in FIG. 7, the computer-executable instructions stored in the memory 703. Alternatively, a function/an implementation process of the processing module 1301 in FIG. 13 may be implemented by invoking, by the processor 701 in FIG. 7, the computer-executable instructions stored in the memory 703, and a function/an implementation process of the interface module 1302 in FIG. 13 may be implemented by using the communication interface 704 in FIG. 7.

One or more of the foregoing modules or units may be implemented by using software, hardware, or a combination thereof. When any one of the foregoing modules or units is implemented by using software, the software exists in a form of computer program instructions, and is stored in the memory. The processor may be configured to execute the program instructions and implement the foregoing method procedure. The processor may be built in a system on chip (SoC) or an ASIC, or may be an independent semiconductor chip. In addition to the core configured to perform operation or processing by executing software instructions, the processor may further include a necessary hardware accelerator, for example, a field programmable gate array (FPGA), a programmable logic device (PLD), or a logic circuit that implements a dedicated logic operation.

When the foregoing modules or units are implemented by using hardware, the hardware may be any one or any combination of a CPU, a microprocessor, a digital signal processing (DSP) chip, a microcontroller unit (MCU), an artificial intelligence processor, an ASIC, a SoC, an FPGA, a PLD, a dedicated digital circuit, a hardware accelerator, or a non-integrated discrete device, and the hardware may run necessary software or does not depend on software to perform the foregoing method procedures.

Optionally, a chip system may include at least one processor and an interface. The at least one processor is coupled to a memory through the interface, and when the at least one processor executes a computer program or instructions in the memory, the method in any one of the foregoing method embodiments is performed. In a possible embodiment, the chip system further includes a memory. Optionally, the chip system may include a chip, or may include a chip and another discrete component. This is not limited.

Optionally, an embodiment further provides a non-transitory computer-readable storage medium. All or some procedures in the foregoing method embodiments may be implemented by a computer program instructing related hardware. The program may be stored in the foregoing non-transitory computer-readable storage medium. When the program is executed, the procedures in the foregoing method embodiments may be included. The non-transitory computer-readable storage medium may be an internal storage unit of the communication apparatus in any one of the foregoing embodiments, for example, a hard disk or a memory of the communication apparatus. Alternatively, the non-transitory computer-readable storage medium may be an external storage device of the communication apparatus, for example, a plug-in hard disk, a smart media card (SMC), a secure digital (SD) card, or a flash card that is configured on the communication apparatus. Further, the non-transitory computer-readable storage medium may include both an internal storage unit and an external storage device of the communication apparatus. The non-transitory computer-readable storage medium is configured to store the computer program and store other programs and data that are required by the communication apparatus. The non-transitory computer-readable storage medium may be further configured to temporarily store data that has been output or is to be output.

Optionally, an embodiment further provides a computer program product. All or some procedures in the foregoing method embodiments may be implemented by a computer program instructing related hardware. The program may be stored in the foregoing computer program product. When the program is executed, the procedures in the foregoing method embodiments may be included.

Optionally, an embodiment further provides computer instructions. All or some procedures in the foregoing method embodiments may be implemented by the computer instructions instructing related hardware (such as a computer or a processor). The program may be stored in the foregoing non-transitory computer-readable storage medium or the foregoing computer program product.

Optionally, an embodiment further provides a communication system, including the node 6011 in the foregoing embodiments and a node that initiates service invocation.

It may be clearly understood by a person skilled in the art from the foregoing description of the embodiments or implementations that, for convenience and brevity of description, division into only the foregoing functional modules is used as an example for description. In actual application, the foregoing functions may be allocated to different functional modules for implementation according to a requirement, for example, an internal structure of an apparatus is divided into different functional modules, to complete all or some of the functions described above.

In the several embodiments, the apparatus and method may be implemented in other manners. For example, the described apparatus embodiments are merely examples. For example, division into the modules or units is merely logical function division. In actual implementation, there may be another division manner. For example, a plurality of units or components may be combined or integrated into another apparatus, or some features may be ignored or not performed. In addition, the displayed or discussed mutual couplings or direct couplings or communication connections may be implemented through some interfaces, and indirect couplings or communication connections between apparatuses or units may be implemented in an electrical, mechanical, or another form.

The units described as separate parts may or may not be physically separate, and parts displayed as units may be one or more physical units, may be located in one place, or may be distributed in a plurality of different places. Some or all of the units may be selected according to an actual requirement to achieve the objectives of the solutions in the embodiments.

In addition, functional units in embodiments may be integrated into one processing unit, or each unit may exist alone physically, or two or more units may be integrated into one unit. The integrated unit may be implemented in a form of hardware, or may be implemented in a form of a software functional unit.

The foregoing descriptions are merely implementations of the embodiments. However, the scope of the embodiments is not limited thereto. Any change or replacement with shall fall within the scope of the embodiments.

1. A communication system, wherein the communication system comprises at least two nodes that are communicatively connected, the at least two nodes maintain at least one blockchain, at least one smart contract is deployed on the at least one blockchain, and each smart contract of the at least one smart contract has a network function of a core network.

2. The communication system according to claim 1, wherein the network function of the core network is configured to provide at least one of the following services:
a subscription service,
an authentication service,
a registration service,
a mobility management service,
a policy management service,
a data processing service,
a charging service,
a session management service,
a computing service,
a sensing service, or
an artificial intelligence service.

3. The communication system according to claim 1, wherein the at least two nodes comprise a first node and a second node, the at least one blockchain comprises a first blockchain, the first node and the second node jointly maintain the first blockchain, a first smart contract and a second smart contract are deployed on the first blockchain, the first smart contract has a first network function of the core network, and the second smart contract has a second network function of the core network.

4. The communication system according to claim 1, wherein the at least two nodes comprise a first node and a second node, the at least one blockchain comprises a first blockchain and a second blockchain, the first node maintains the first blockchain, the second node maintains the second blockchain, a first smart contract is deployed on the first blockchain, a second smart contract is deployed on the second blockchain, the first smart contract has a first network function of the core network, and the second smart contract has a second network function of the core network.

5. The communication system according to claim 3, wherein information about the first smart contract is stored in the first blockchain or the first node, and the information about the first smart contract comprises an identifier of the first smart contract.

6. The communication system according to claim 5, wherein the information about the first smart contract further comprises at least one of the following:
an identifier of the first blockchain,
information about an execution node of the first smart contract,
information about a node on which the first smart contract is deployed,
key information of the first smart contract, token access manner information of the first smart contract,
version information of the first smart contract,
an input parameter of the first network function, or
information about the first network function.

7. The communication system according to claim 1, wherein the communication system further comprises a third node, and the third node is configured to parse an invocation request for a service, to obtain invocation information of at least one smart contract corresponding to the invocation request for the service.

8. The communication system according to claim 7, wherein the invocation request for the service is from one or more of a terminal, a radio access network node, an application function network element, a network function network element, or an operation, administration and maintenance network element.

9. The communication system according to claim 1, wherein any one of the at least two nodes is configured to receive an invocation request for a smart contract.

10. The communication system according to claim 9, wherein the invocation request for the smart contract is from one or more of a terminal, a radio access network node, an application function network element, a network function network element, or an operation, administration and maintenance network element.

11. The communication system according to claim 1, wherein the network function of the core network comprises at least one of the following: an access function, a mobility management function, a network repository function, unified data management, an authentication server function, a session management function, a user plane function, a policy control function, a network exposure function, a computing plane function, a data plane function, or a smart plane function.

12. The communication system according to claim 1, further comprising:
a radio access network node communicatively connected to the at least two nodes, and the radio access network node is configured to invoke the smart contract deployed on the at least one blockchain.

13. The communication system according to claim 1, further comprising:
a network element of the core network that is communicatively connected to the at least two nodes, and the network element of the core network is configured to invoke the smart contract deployed on the at least one blockchain, or the network element of the core network is configured to provide a service for the smart contract deployed on the at least one blockchain.

14. A method comprising:
obtaining an invocation request for a first service; and
determining invocation information of at least one smart contract corresponding to the invocation request for the first service, wherein any one of the at least one smart contract is deployed on a blockchain and has a network function of a core network.

15. The method according to claim 14, wherein the network function of the core network is configured to provide at least one of the following services: a subscription service, an authentication service, a registration service, a mobility management service, a policy management service, a data processing service, a charging service, a session management service, a computing service, a sensing service, or an artificial intelligence service.

16. The method according to claim 14, wherein the at least one smart contract comprises a first smart contract, and the method further comprises:
sending the first invocation request to a scheduling node of the first smart contract, wherein the first invocation request is used to invoke the first smart contract; or,
sending the first invocation request to an execution node of the first smart contract, wherein the first invocation request is used to invoke the first smart contract.

17. The method according to claim 14, further comprising:
receiving an execution result of the first smart contract.

18. A method comprising:
obtaining a first invocation request, wherein the first invocation request is used to invoke a first smart contract, the first smart contract is deployed on a first blockchain, and the first smart contract has a first network function of a core network; and
executing the first smart contract to obtain an execution result of the first smart contract.

19. The method according to claim 18, wherein the first network function is configured to provide a subscription service, an authentication service, a registration service, a mobility management service, a policy management service, a data processing service, a charging service, a session management service, a computing service, a sensing service, or an artificial intelligence service.

20. The method according to claim 18, wherein the first smart contract is used to invoke a second smart contract, and the method further comprises:
sending the second invocation request to a scheduling node of the second smart contract, wherein the second invocation request is used to invoke the second smart contract; or
sending the second invocation request to an execution node of the second smart contract, wherein the second invocation request is used to invoke the second smart contract.
